(19) United States
(12) Patent Application Publication
(10) Pub. No.: US 2015/0107762 A1
(43) Pub. Date: Apr. 23, 2015

(54) Processes for the Removal of Labels from Materials

(71) Applicant: Avery Dennison Corporation, Glendale, CA (US)

(72) Inventors: Hemant R. NAIR, Maharashtra (IN); Santosh L. HIRE, Maharashtra (IN); Peter J. HEEDERIK, Hillegom (NL)

(21) Appl. No.: 14/518,444

(22) Filed: Oct. 20, 2014

Related U.S. Application Data
(60) Provisional application No. 61/892,554, filed on Oct. 18, 2013.

(51) Int. Cl. B32B 43/00; B32B 38/10

(52) U.S. Cl. CPC B32B 43/006; B32B 38/10
USPC 156/247; 156/703; 156/711; 156/706

(57) ABSTRACT

A method for removing a label affixed to a material includes exposing the label to one or more of heat, hot gas, or hot liquid having a predetermined temperature, in the absence of any caustic solution, for a period sufficient for the label to release from the material to which it was affixed.

### CROSS-REFERENCE TO RELATED APPLICATION

The present application claims the benefit of U.S. Provisional Application No. 61/892,554 filed Oct. 18, 2013, which is incorporated herein by reference in its entirety.

### BACKGROUND OF THE INVENTION

Some materials, such as bottles and containers, may be recycled or reused. Some materials for such reuse or recycling may have a label affixed thereon. In some embodiments, the present disclosure is directed to processes that may be used to remove such labels.

### SUMMARY OF THE INVENTION

In one embodiment, the disclosure includes a method for removing a label affixed to a material. The method may comprise exposing the label to one or more of heat, jetted hot gas, or sprayed hot liquid having a predetermined temperature. The exposure may be continued for a period sufficient for the label to release from the material and wherein the label does not shrink. The label removal is conducted in the absence of any caustic solution.

The following description illustrates one or more embodiments of the disclosure and serves to explain the principles and exemplary embodiment of the disclosure.

### BRIEF DESCRIPTION OF THE DRAWINGS

FIG. 1A is a cross section of a label.

FIG. 1B is a cross section of the label of FIG. 1A as applied to a cylindrical container.

FIGS. 2-9 are cross sections of embodiments of label constructions.

FIG. 10A is a cross section of a label.

FIG. 10B is a cross section of the label of FIG. 10A as applied to a cylindrical container.

FIGS. 11-18 are cross sections of embodiments of label constructions.

FIG. 19A is a sectional view of an embodiment of a label containing two layers.

FIG. 19B is a sectional view of an embodiment of a containing three layers.

FIG. 19C is a sectional view an embodiment of a containing three layers.

FIG. 19D is a sectional view of an embodiment of a containing four layers.

FIG. 19E is a sectional view of an embodiment of a containing four layers.

FIG. 20 is a perspective view of an embodiment of a first film layer of a label showing a machine direction and a transverse direction.

FIG. 21 is a sectional view of an embodiment of a label containing a release liner.

FIG. 22 is a perspective view of an embodiment of a label attached to a cylindrically-shaped container.

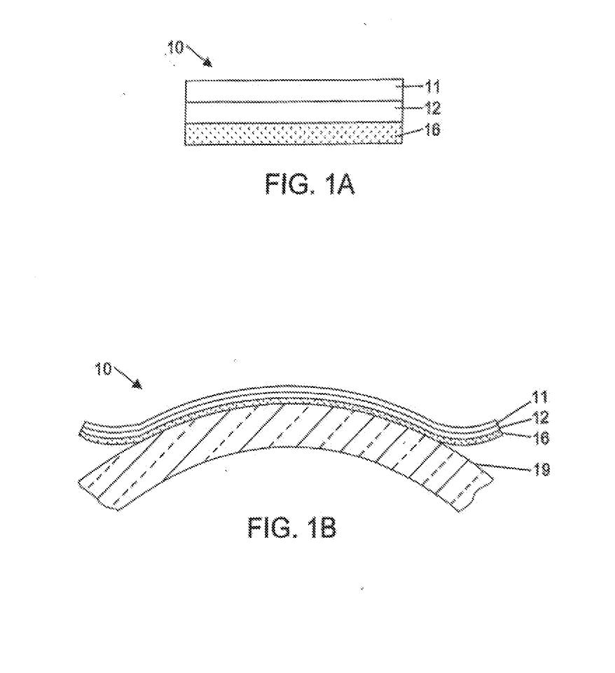

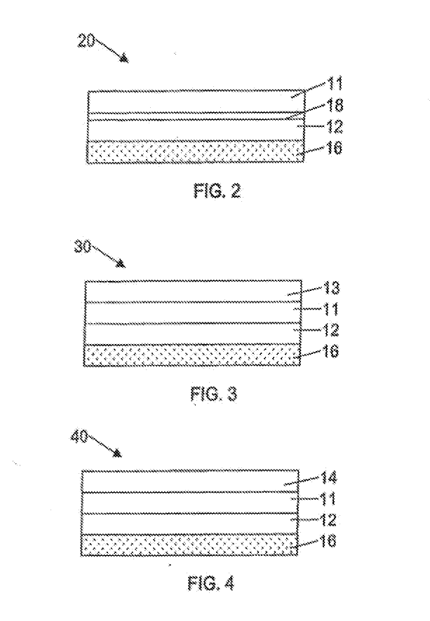

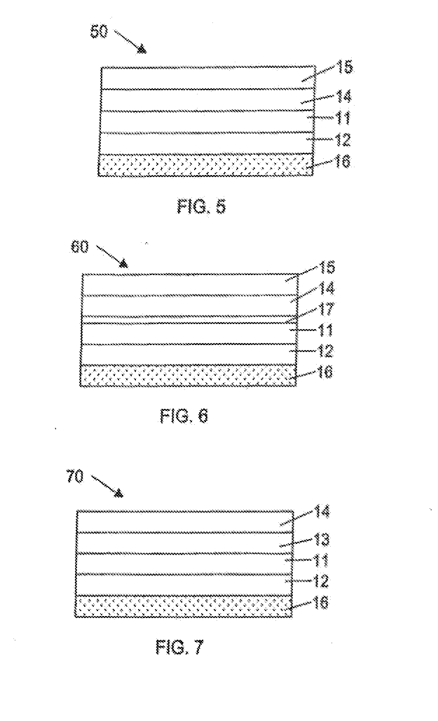

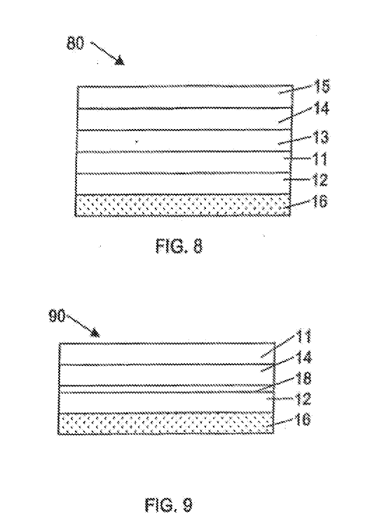

### DETAILED DESCRIPTION OF EXEMPLARY EMBODIMENTS

Reference will now be made in detail to exemplary embodiments of the present disclosure, one or more examples of which are illustrated in the accompanying drawings. Each example is provided by way of explanation of the disclosure and not by limitation of the disclosure. It will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

The present disclosure includes processes for removing labels from materials, such as bottles or containers that are being prepared for recycling or reuse. In one embodiment, labels may be removed from glass containers. In other embodiments, processes of the present disclosure may be used on other materials having affixed labels, such as materials like polypropylene, polyolefin, polyvinyl chloride (“PVC”), polyethylene terephthalate (“PET” and “PET LV”), polyethylene, plastics, or combinations thereof, wherein the foregoing are illustrative and are not limiting. In some embodiments, the materials form containers.

In some embodiments, processes of the present disclosure for removing labels from an underlying material may include exposing a label to heat, hot gas, hot liquid, or combinations thereof. In some embodiments, a label may be exposed to hot air, hot water, or hot water vapor (also referenced as “steam” herein). In some embodiments, a label may be exposed to heat in any suitable manner, including by radiation or a heater. In some embodiments, hot gas, or hot liquid may be applied by jets or any mechanism that sprays or hoses the gas or liquid into contact with a label. In some embodiments, a label may be exposed to one or more of heat, hot gas, or hot liquid concurrently and/or sequentially.

Heat may be applied at a temperature and for an exposure period to completely or substantially remove a label and any adhesive affixing the label to a material. For example, to the extent possible for each of heat, gas, or liquid may be applied to a label at a temperature of in the range of about 50° C. to about 800° C., including in the range of about 600° C. to about 800° C. In some embodiments, heat may be applied at a temperature at or greater than about 50° C. or at or greater than about 60° C. In some particular embodiments, hot gas may be applied at a temperature in the range of about 50° C. to about 150° C. In some embodiments, steam may be applied to a label at a temperature of about 100° C. or at higher temperatures if the pressure is increased. In addition, hot liquid may be applied to a label at a temperature in the range of about 50° C. to about 99° C. In some embodiments, hot air or hot liquid may be applied to a label at a temperature at or above about 50° C. and, in other embodiments, hot air or hot liquid may be applied at or above about 60° C. The temperatures in the foregoing ranges and in all ranges disclosed herein shall include each individual increment within the disclosed range. In some embodiments, heat may be applied such that the label and the material upon which the label is affixed does not burn or melt.

In some embodiments, heat, hot gas, or hot liquid may be applied to a label at a temperature such that the label itself and/or the material upon which a label is affixed reach a certain desired temperature. In some embodiments, such labels and/or materials may be heated to a temperature at or above about 50° C. or about 60° C. In some embodiments, such labels and/or materials may be heated to a temperature in the range of about 40° C. to about 150° C. In some embodiments using shrink films as described herein, the label may be heated to a temperature of at least about 80° C. In some embodiments, dryers may heat the material and/or the label to a temperature in the range of about 60° C. to about 75° C. in a recycling process or, alternatively, within the range of about 100° C. to about 150° C. in a material reuse process. In other embodiments, steam may be used to heat the material and/or the label to a temperature of about 100° C.

In some embodiments, hot liquid or hot gas may be applied to a label at standard pressure. In other embodiments, hot liquid or hot gas may be applied to a label using higher pressure and/or in a turbulent manner. By way of example, a high pressure jet spray may be operate at a pressure of about 20 bar to about 200 bar or alternatively about 20 bar to about 150 bar, including each intermittent value in the foregoing ranges. In addition, flow volume may be adjusted in some embodiments to deliver the desired amount of gas or liquid to a label. In some embodiments, a reduced volume of liquid may be provided at a high pressure as compared with the volume required to remove a label without increased pressure. For example, hot liquid, such as water, may be applied to a label, such as through a jet or spray nozzle. In similar fashion, hot gas, such as water vapor, may be applied at a label, such as through a jet or nozzle. In some embodiments, hot gas or hot liquid may be provided to a label in a continuous flow, and in other embodiments hot gas or hot liquid may be provided to a label in intermittent bursts.

In some embodiments, heat, hot gas and/or hot liquid may be applied to the entire label, a portion of the label, or to segments of the label. In some embodiments, steam may be provided to a label in a steam tunnel. In some embodiments of the present disclosure, heat, hot gas and/or hot liquid may applied to a particular portion of a label, such as at the edges or corners of a label, before directing the heat, hot gas, and/or hot liquid to other portions of the label. In addition, jets in some embodiments may deliver hot gas or hot liquid to a label at a predetermined angle.

The exposure time of a label to heat, hot liquid, or hot gas may vary depending upon the label and any adhesive, the container material, and the temperature. In addition, with respect to hot liquids and hot gases, the force and volume may also influence the exposure time. In some embodiments, labels may be removed using sufficient temperature and pressure to remove the label within about ten seconds to about two minutes, including each intermittent value therein. In other embodiments, sufficient temperature and pressure may be used to remove a label in less than about sixty seconds. In still other embodiments, a label may be removed in about thirty to about forty seconds. In some embodiments, the exposure duration may depend upon the starting temperature of the label material and, in yet other embodiments, the temperature of the heat, gas, or liquid being applied to a label may be varied depending upon the temperature of the label or material as measured, calculated, or observed at any point during a process of the present disclosure.

In some embodiments, the label may be exposed to heat, hot gas, or hot liquid in the absence of any caustic or other alkali compounds. In other embodiments, the label may be exposed to heat, hot gas, hot liquid, or hot vapor substantially in the absence of any caustic or other alkali compounds. For example, in some embodiments, less than about 1% caustic may be present when heat, hot gas, or hot liquid is exposed to the container to remove a label, and in other embodiments less than about 0.5% caustic may be present during the label removal process. As a result of the lack of any caustic compounds in some embodiments, no treatment of any discarded liquid is required. In additional or alternative embodiments, no other additives are applied during the label removal process.

In some embodiments of the present disclosure, a label affixed to a material may be entirely, or alternatively substantially, removed prior to the material being washed for reuse or processed for recycling. In this regard, the label and label adhesive residue are absent, or are substantially absent, from the any subsequent washing steps, thereby avoiding polluting any subsequent washing liquid. In embodiments in which a container bearing a label is being recycled, the container, such as a glass container, may optionally be broken into pieces in some embodiments prior to the removal of the label.

By way of example, labels affixed to glass bottles, such as beverage bottles, may be removed from the glass bottles using embodiments of the present disclosure. The labels affixed to the bottles may be exposed to heat, hot liquid, or hot gas as described above and until the label and any adhesive are substantially removed from the bottles. In some embodiments, such exposure may occur prior to being the bottle being cleaned for reuse. Following the label removal, any suitable process for preparing the bottle for reuse may be employed, such as soaking the bottle in a caustic bath for cleaning and then spraying the inside of the bottle with a sterilization liquid.

As indicated above, embodiments of the present disclosure may also be used to remove labels from bottles during a recycling process. In some embodiments, the labels affixed to the bottles may be exposed to heat, hot liquid, or hot gas as described above and until the label and any adhesive are substantially removed from the bottles. In other embodiments, the bottles may be broken into pieces, called cullet, and then the cullet may be exposed to heat, hot liquid, or hot gas as described above and until the label and any adhesive are substantially removed from the bottles. In some embodiments, label removal processes of the present disclosure may be practiced without previously exposing the label to other moisture or increased temperatures and also without waiting any degradation of the label. In any scenario, the bottles or the cullet may be cleaned after the label is removed, such as by washing the bottles or cullet in a caustic bath. In this regard, the label removal may be conducted apart from any washing of the bottle or other material upon which the label is affixed, although hot liquid, gas, or heat may contact the bottle or other material during label removal (but not constitute washing of the bottle or other material).

In some embodiments, labels affixed to materials may be removed before being loaded into conventional machinery for processing or washing the material for reuse or recycling. In this manner, conventional machinery does not require adjustment or expensive adaptations to practice the present disclosure. In this manner, the present disclosure can be practiced, in some embodiments, using equipment apart from conventional recycling or reuse processing machinery for materials. In addition, such embodiments avoid polluting any subsequent processes with label or adhesive residue. By way of further illustration, some embodiments of the present disclosure complete label removal from a material solely by the exposure of heat, hot liquid, hot gas, or a combination thereof and without additional removal mechanisms such as brushing, scraping, or other procedures.

The present disclosure may be suitable for use with any label, and one of ordinary skill in the art will appreciate that such labels may be manufactured from any conventional materials and any filmic materials suitable for labels. By way of example, and without limitation, labels used with the present disclosure may be manufactured using a polymeric material such as a polyester, polyolefin, polyvinyl chloride, polystyrene, polypropylene, and copolymers and/or blends thereof. Other label materials may include materials selected from polylactic acid, cellophane, styrenics, polylactic acid, polycarbonate, polyamides, polystyrene, mixtures and copolymers of any of the foregoing. In addition, the present disclosure may be employed to remove labels from any type of materials, including containers comprising glass, polymers, metals, or any other suitable container material. An exemplary container may be glass bottles or polyethylene bottles. In particular embodiments, labels may be prepared using polyvinyl chloride (“PVC”), polyethylene terephthalate (“PET” and “PET LV”), polyolefin, polystyrene, oriented polystyrene (“OPS film”), polylactic acid (“PLA film”), polyolefins, or combinations thereof. In one embodiment, labels removed using embodiments of the present disclosure may be made from polyethylene terephthalate glycol-modified (“PET-G”). In still another embodiment, labels may be prepared using paper or paper-like products.

In some embodiments, labels used in conjunction with the present disclosure may be a shrink sleeve label (also referred to as a shrink fit or shrink label) or stretch sleeve label (also referred to as a stretch fit or stretch label), both of which, and their methods of manufacture, are known in the art. By way of example, shrink labels or stretch labels may include polyvinyl chloride (PVC), polypropylene terephthalate glycol (PETG), oriented polypropylene (OPP), Polylactide (also referenced as polylactic acid) (PLA), expanded polystyrene (EPS), and polystyrene. A shrink fit label may be in a state in which it is larger in size than an article to which it is to be applied, and the label is shrunk using heat or other means to provide a generally tight fit to the article, such as a bottle. A stretch fit label may be in a state in which it is smaller in size than an article to which it is to be applied, and the label is stretched onto the article to provide a generally tight fit. Various embodiments of stretch fit and shrink fit labels are known in the art and within the scope of the present disclosure. In some embodiments, no adhesive is employed to affix a shrink fit label to a container. In other embodiments, a label may be applied to affix a shrink label to a container. In still other embodiments, a shrink label may be applied to a material using adhesive, including, for example, a removable adhesive, and without applying heat. Depending upon the type of film used, shrink labels may have shrink levels of any suitable degree. In some embodiments, depending upon the type of film used, shrink labels may have shrink levels in the range of about 5% to about 70%, including each intermittent value therein.

Labels removed using the present disclosure may be configured in any manner suitable for a particular embodiment. By way of example, some labels may have a thickness of about 10 to about 100 microns, including each intermittent value therein. In some embodiments, labels may have a thickness of about 20 to about 60 microns. Labels may also have a single layer or multiple layers, and the labels may be prepared using clear films or colored films may be used.

In some embodiments, labels removed using a process of the present disclosure may be adhered to a material using an adhesive. In some embodiments, an adhesive may be used that remains upon the label upon exposure to heat, hot gas, and/or hot liquid may be used. In this manner, as a label is removed from an underlying material, such as a bottle, the adhesive is removed with the label and does not remain upon the underlying material. In this regard, the underlying material may not contain any, or substantially any, adhesive residue, which may be advantageous if the underlying material is processed for re-use or recycling. In other embodiments, sufficient heat, hot liquid, and/or hot gas may be applied to the label area to ensure that any residual adhesive is removed from the underlying material upon which the label was previously affixed.

In some embodiments, labels removed using processes of the present disclosure may be adjoined to an underlying material using a water-sensitive adhesive and/or a partially water-sensitive adhesive, such as a pressure-sensitive adhesive (PSA). In some embodiments in which a label is removed from a material that is to be recycled, adhesives may be used that only have ample water sensitivity when the material upon which they are applied, such as a glass bottle, is broken, thereby exposing the adhesive to moisture. However, in some embodiments, the water sensitivity of the adhesive should have only minor, if any, effects when the labels are being produced, converted for printing, or applied to the material, or when the material upon which the label is affixed is being transported, stored, sold in retail establishments, or used by a consumer.

In some embodiments, adhesives used in accordance with the present disclosure may include, without limitation, emulsions, solutions, hot melts, ultraviolet hot melts, and solvent-based adhesives. One of ordinary skill in the art will appreciate that, in some embodiments, adhesives of the present disclosure may be cross-linkable, such as by using, by way of example, metal complexes, aziridines, isocyanites, ultraviolet curing, or electron beam curing. In some embodiments, adhesives of the present disclosure may also include color dyes, fillers, and/or stabilizers, all of which are known in the art. Exemplary formulations that may be suitable for use in some embodiments of the present disclosure are set forth in U.S. Pat. No. 5,183,841, the contents of which is incorporated herein in its entirety.

By way of illustration, adhesives used in labels removed using processes of the present disclosure may include, in some embodiments, components providing a hydrophilic nature to the adhesive. For instance, some adhesives may include hydrophilic comonomers such as vinyl pyridine, beta carboxy ethyl acrylate, acids with long side chain spacers, and macromonomers with hydrophilic blocks. Some embodiments of adhesives having the desired water sensitivity may include high molecular weight hydrophilic polymers. By way of example, such polymers may include, without limitation, polyethylene oxide, poly (meth)acrylic acids/salts, polyamides, and/or polyvinylpyrrolidone. Adhesive may also include monomers, such as dimethylaminoethyl methacrylate. Other such monomers and polymers will be readily apparent to one of ordinary skill in the art in light of the disclosure herein. Notwithstanding the foregoing, in some embodiments, it may be necessary to ensure that an adhesive is not overly water sensitive, which could result in undesirable results, such as decreased water whitening resistance, label edge dampening, and label release in humid or moist environments prior to recycling.

In some embodiments of the present disclosure, an acrylamide may be added to any monomers having solubility parameters greater than about 10.5 in order to obtain the desired water sensitivity. In some applications, acrylamide may be added in an amount that is greater than about 5% by weight. Any suitable acrylamide may used, such as N,N-dimethylacrylamide (NNDMA) adhesives with suitable water sensitivity may be prepared using monomers with solubility parameters greater than about 10.5

Adhesives used in conjunction with the present disclosure may include high molecular weight humectants, such as glycerol. In addition, surfactants, such as Pluronic® and Tetronic®, both available commercially from BASF, which have blocks of hydrophilic (PEO) and hydrophobic (PPO) moieties may be used. In some adhesives, such as hot melt adhesives which may be generally considered as hydrophobic, surfactants having blocks of hydrophilic and hydrophobic groups may provide improved results. For example, such surfactants may provide compatibility with acrylics and also create hydrophilic domains in the adhesive. In addition, thickeners/lattices, such as Acrysol ASE-60, available from Dow Chemical Company, and the like may be used in some adhesives used in the present disclosure. Furthermore, some adhesives contemplated herein may include tackifiers, such rosin acids/salts. In some embodiments, additives, such as poly(2-ethyl-2-oxazoline) (such as those available under the commercial brand Aquazol), poly(vinyl ethers) (such as those available under the commercial brand Lutenol), and/or polyvinyl alcohol may be added to the adhesive formulation. In some instances, polyvinyl alcohol may be added, additionally or alternatively, as a stabilizer. For hot melt adhesives, polymer additives such as acid functional aliphatic (such as Ricobond 5110 from Cray Valley) and aromatic (Ricobond 5120 from Cray Valley) may be used to increase the hydrophilic nature of an adhesive.

The foregoing examples are not limiting, and other components may be used to alter the water sensitivity of an adhesive. For instance, components such as styrene maleic anhydride copolymers may be added to styrene domains may render them water sensitive. One of ordinary skill in the art will appreciate that any adhesives having suitable water sensitivity may be removed using certain embodiments of the present disclosure.

In some embodiments, labels removed from materials may be, prior to removal, affixed to the material using other or additional types of adhesives. In one embodiment of the present disclosure, an acrylic emulsion pressure sensitive adhesive may contain a pressure sensitive adhesive copolymer of a plurality of copolymerizable monomers. The copolymerizable monomers include (a) one or more alkyl acrylates having from about 4 to about 12 carbon atoms in the alkyl group; (b) one or more acid monomers; (c) at least one hard monomer; and (d) optionally, at least one multifunctional crosslinking monomers.

In this exemplary embodiment, the acrylic emulsion pressure sensitive adhesive copolymer, in one embodiment, comprises a plurality of copolymerizable monomers, the major portion of which is one or more alkyl acrylates having about 4 to about 12 carbon atoms in the alkyl group. Non-limiting examples of alkyl acrylates having about 4 to about 12 carbon atoms in the alkyl group include butyl acrylate, hexyl acrylate, heptyl acrylate, n-octyl acrylate, iso-octyl acrylate, 2-ethylhexyl acrylate, isobutyl acrylate and nonyl acrylate. In one embodiment, the copolymer comprises about 75% to about 90% by weight of the alkyl acrylate having from about 4 to about 12 carbon atoms in the alkyl group. In another embodiment, the copolymer comprises about 77% to about 85% by weight of the alkyl acrylate. The copolymer comprises about 0.25% up to about 5% by weight, or from about 0.5% to about 3% by weight of at least one unsaturated carboxylic acid containing from 3 to about 8 carbon atoms. Non-limiting examples of ethylenically unsaturated carboxylic acids include acrylic acid, methacrylic acid, beta-carboxyethyl acrylate, itaconic acid and beta-carboxyethyl acrylate.

As used herein, the term “multifunctional crosslinking monomer” means a monomer means a monomer that is copolymerizable with acrylic monomers and that has at least one carbon-carbon double bond and at least one other functional group capable of entering into a polymerization or crosslinking reaction. In one embodiment, the copolymer comprises up to about 1% by weight of at least one multifunctional crosslinking monomer. In another embodiment, the copolymer comprises up to about 0.5%, or from about 0.01% to about 0.5% by weight of at least one multifunctional crosslinking monomer. Non-limiting examples of such monomers include multifunctional (meth)acrylates, e.g., diacrylates, triacrylates, dimethyacrylates, and trimethylacrylates; multifunctional allylic compounds, e.g., diallyl maleate and allyl methacrylate; multifunctional crosslinking monomers having a vinyl group; and multifunctional crosslinking monomers having a reactive heteroatom-containing functional group such as the imidazolidone group. A non-limiting list includes the monomers shown in Table 1:

TABLE 1

| Multifunctional Monomer | Abbreviation |
|---|---|
| Allyl Methacrylate | AMA |
| Diallyl Maleate | DAM |
| Divinyl Benzene | DVB |
| Ethylene Glycol Dimethacrylate | EGDMA |
| N,N′-methylene-bis-acrylamide | NNMBA |
| Diallyl Phthalate | DAP |
| Butanediol Diacrylate | BDD |
| Hexanediol Diacrylate | HDDA |
| Tripropylene Glycol Diacrylate | TPGDA |
| Triallyl Cyanurate | TAC |
| Tetraethylene Glycol Diacrylate | TEGDA |
| Butanediol Dimethacrylate | BDDMA |
| Tetraethylene Glycol Dimethacrylate | TEDMA, TEGMA |
| Trimethylolpropane Triacrylate | TMPTA |
| Trimethylolpropane Trimethacrylate | TMPTMA, TRIM |
| Trimethylolpropane Diallyl Ether | TMPDAE |
| Imidazolidone Methacrylate | MEIO |

As used herein, the term “hard monomer” refers to a monomer the homopolymer of which is not inherently tacky at ambient temperatures and which has a Tg greater than about −25° C. Non-limiting examples include methyl and ethyl acrylate, methyl and ethyl methacrylate, vinyl acetate, styrene, and acrylonitrile. In one embodiment, the copolymer comprises about 10% to about 20% by weight of hard monomer, or about 15% to about 20% by weight of hard monomer.

The monomers in this embodiment may be polymerized in the presence of a surfactant or a mixture of surfactants. The total amount of surfactant used can be in the range of about 0 to about 7%, or about 1.3% to about 5% based on the weight of the polymer. Anionic surfactants, nonionic surfactants, and combinations thereof may be used. Suitable anionic surfactants include, for example, alkyl sulfates, alkyl phenol ethoxysulfates, alkyl sulfonates, alkaryl sulfonates and alkyl sulfosuccinates, such as for example, sodium lauryl sulfate, nonyl phenol ethoxy(4)sulfate, sodium dodecyl benzene sulfonate, disodium dioctyl sulfosuccinates, as well as mixtures thereof. Suitable nonionic surfactants include, for example, ethoxylated alkyl phenols, poly(ethylene oxide/propylene oxide) block copolymers, such as, for example, ethoxylated (10-60 moles ethylene oxide) nonyl phenol, as well as mixtures thereof.

In one embodiment, a combination of surfactants may be used in the course of polymerizing the monomers, with anionic surfactants being particularly useful. In particular, a mixture of two different surfactants may be used. In one embodiment, the first type of surfactant is a sulfate of an ethoxylated alcohol, e.g., a sodium lauryl ether sulfate. Non-limiting examples include Disponil FES 77 and Disponil FES 993 from Cognis Corp. and Polystep B-19 from Stepan Company. The second type of surfactant is, in one embodiment, a sulfosuccinate or derivative, e.g., a dioctyl ester of sodium sulfosuccinic acid. Non-limiting examples include Aerosol OT-75 from Cytec Industries, Inc. and Disponil SUS IC 875 from Cognis Corp. In another embodiment, the second type of surfactant is a modified fatty alcohol polyglycolether. Non-limiting examples include Disponil AFX 1080 and Disponil AFX 2075 from Cognis Corp.

In addition to the monomers and surfactants described above, additional ingredients, reagents, processing aids, and other components may be used in preparing embodiments of adhesives within the scope of the disclosure. A non-limiting list includes polymerization color dyes, fillers, stabilizers, catalysts (initiators), chain transfer agents, neutralizers, accelerators, tackifiers, defoaming agents, thickeners or rheology modifiers, buffers, antioxidants and biocides.

In some embodiments, suitable thermal polymerization initiators include, but are not limited to, sodium persulfate, potassium persulfate, ammonium persulfate, sodium perborated, and ammonium or alkali metal peroxy disulfate salts. The initiator may be used alone or in combination with a minor amount of one or more reducing components or activators, such as, for example sodium sulfoxylate formaldehyde, alkali metal and ammonium salts of sulfur-containing acids, such as sodium sulfite, bisulfite, thiosulfate, hydrosulfite, sulfide, hydrosulfide or dithionite, formadinesulfinic acid, hydroxymethanesulfonic acid, acetone bisulfite, amines such as ethanolamine, glycolic acid, glyoxylic acid hydrate, ascorbic acid, isoascorbic acid, lactic acid, glyceric acid, malic acid, 2-hydroxy-2-sulfinatoacetic acid, tartaric acid and salts of the preceding acids.

A chain transfer agent may be employed in the preparation of an adhesive contemplated herein. The weight average molecular weight (Mw) of the emulsion polymer may be adjusted through the addition of a chain transfer agent, such as n-dodecyl mercaptan, during emulsion polymerization to give a suitable balance of adhesive and cohesive strength. Suitable chain transfer agents include, but are not limited to, isopropanol, halogenated compounds, n-butyl mercaptan, n-amyl mercaptan, n-dodecyl mercaptan, t-dodecyl mercaptan, alkyl thioglycolate, mercaptopropionic acid, and alkyl mercaptoalkanoate. According to one embodiment of the disclosure, chain transfer agent is not required but in some embodiments it is used in an amount of from 0.001 to 0.5, including from 0.0025 to 0.1, moles per kg dry polymer weight. Linear or branched C₄-C₂2 alkyl mercaptans such as n-dodecyl mercaptan and t-dodecyl mercaptan are particularly useful.

In the preparation of some acrylic emulsion polymers, a neutralizer may included. By “neutralizer”, what is meant is a basic material that is capable of entering into an acid-base reaction with the acid monomer. Suitable neutralizers include poly-hydroxy functional amines, such as for example, triethanolamine, 2-[bis-(2-hydroxyethyl)-amino]-2-hydroxymethyl propane-1,3-diol (bis tris methane), 2-amino-2-(hydroxymethyl)-1,3-propanediol (trizma base), N-methyl-D-glucamine, N,N,N′N′-tetrakis-(2-hydroxyethyl)-ethylenediamine and N,N,N′N′-tetrakis-(2-hydroxypropyl)-ethylenediamine.

An organic salt, for example, sodium citrate, sodium gluconate or sodium acetate may be used in combination with the neutralizer to enhance the removability of the adhesive. An inorganic acid salt may also be used. Alternatively, an organic acid neutralized by a hydroxy amine can be used. Non-limiting examples of organic acids include acetic acid, p-toluene sulfonic acid, citric acid, gluconic acid, maleic acid and dodecylbenzene sulfonic acid. The organic acids can be either added to the water phase during the polymerization or added post polymerization.

Chemical crosslinkers may or may not be present in the composition. If present, the external crosslinkers are provided in an amount up to about 5 by weight, based on the weight of dry adhesive, to further increase the cohesive strength. Non-limiting examples of external crosslinkers include chromium acetate, zirconium ammonium carbonate, aluminum acetate, polyaziridines, carbodiimides and the like. For polyaziridines, the amount of crosslinker used is typically less than about 1% by weight, or about 0.6% or less by weight, based on the weight of dry adhesive.

In some embodiments, an adhesive composition of the present disclosure may contain an emulsifiable wax and a plasticizer. Non-limiting examples of emulsifiable waxes include emulsified petroleum resins, paraffin waxes, oxidized paraffin waxes, microcrystalline waxes, camauba waxes, montan waxes, polyethylene waxes, and the like. Non-limiting examples of plasticizers include phthalates, such as butyl benzyl phthalate, and dioctyl phthalate; adipates; benzoates; citrates, such as triethyl citrate and acyl tributyl citrate; maleates; oleates; phosphates; sebacates; stearates; epoxidized vegetable oils; rosin derivatives, and polymeric plasticizers, such as low molecular weight acrylic polymers that lower the Tg and storage modulus of the PSA.

In some embodiments, adhesive may be applied directly to a label or to a release liner, and such application may be accomplished by any conventional means. In addition, adhesive may be applied in any amount suitable for the desired releasability during the recycling process and non-releasability during ordinary conditions. By way of example, adhesive may be applied at about 2 to about 100 grams per square meter (g/m²).

The adhesion level of labels of the present disclosure may be varied as required by specific applications. In some embodiments, adhesives may be used such that labels are ultra-removable, removable, semi-removable, repositionable, or permanent. By way of example, the adhesion level may be in the range of greater than about 0 N/inch to greater than about 20 N/inch, including each intermittent value between greater than about 0 N/inch to greater than about 20.

As indicated above, water sensitive adhesives may be used in certain embodiments of the present disclosure. However, in some embodiments, it may be desirable that the adhesives are not overly water sensitive. For example, in some embodiments, labels may be formed in a wide roll and then slit into smaller rolls. In such embodiments, adhesive that is sensitive to air moisture could result in softened roll edges, which could pollute slitting equipment, and tacky roll edges, which could negatively impact printing of the labels. Similarly, water sensitivity may impact the printing process for labels, such as by polluting printing presses. In addition, over sensitivity may complicate the label application processes, such as by polluting the label applicator or obtaining poor label dispensability if tacky label edges result.

In addition, in some embodiments, adhesives for labels may chosen to avoid excessive water whitening on the label from moist environments, such as when a label is on a product stored refrigerator or ice chest or used in a high humidity location, such as in tropical regions. In addition, adhesives of labels of the present disclosure may avoid tacky label edges from moisture, which may not be desirable to consumers. Furthermore, many labels are applied to materials, such as beer bottles, using high speed processes. In some embodiments, labels of the present disclosure may have a water sensitivity that does not impact such high speed processes. In addition, adhesives and label materials may be used that result in relatively quick adhesion to materials after application. Such quick adhesion avoids complication during the label application process, particularly since containers may be filled before or after label application.

Other desired characteristics may also be considered in selecting an adhesive for labels to be removed by processes of the present disclosure. For example, an adhesive may be selected such that, during consumer use, the adhesion is high enough to avoid movement of the label over the material surface. In addition, in some embodiments, an adhesive may be selected to ensure adequate anchorage to a material. In some embodiments, an adhesive may be selected that does not dissolve during the applicable recycling process in order to avoid polluting the recycling site. Finally, as a final example, the adhesive may be selected so as not to bloom (i.e., sweat out) from the affixed label. The foregoing parameters are illustrative of criteria that may be used in selecting adhesives for use in some embodiments of the present disclosure.

The following examples provide for the preparation of certain adhesives that may be used in some embodiments of the present disclosure:

### Preparation of Pressure Sensitive Adhesive Examples

### Preparation of Base Polymers

### Examples A-D

Base polymers are prepared by free-radical emulsion polymerization according to the following procedure, using the components identified in the table below:

TABLE 2

| | Polymer A | Polymer B | Polymer C | Polymer D | |
|---|---|---|---|---|---|
| Component | mass (g) | | | | Stage |
| de-ionized water | 417.10 | 376.40 | 373.92 | 384.12 | initial reactor |
| potassium persulfate | 4.76 | 4.55 | 4.74 | 0 | loading |
| ammonium | 0 | 0 | 0 | 4.69 | |
| persulfate | | | | | |
| de-ionized water | 198.56 | 220.28 | 223.85 | 226.61 | pre-emulsion |
| Disponil FES 77 | 69.78 | 70.73 | 69.42 | 68.75 | |
| Disponil SUS IC 875 | 13.08 | 13.14 | 12.96 | 12.84 | |
| citric acid | 0 | 0 | 30.16 | 31.47 | |
| monohydrate | | | | | |
| 2-ethylhexyl acrylate | 1312.35 | 1323.70 | 1306.23 | 1293.52 | |
| methyl methacrylate | 194.43 | 295.56 | 193.94 | 192.05 | |
| methyl acrylate | 97.10 | 0 | 96.97 | 96.03 | |
| acrylic acid | 16.30 | 16.42 | 16.20 | 16.05 | |
| EGDMA | 0.57 | 0 | 0 | 0 | |
| DAM | 0 | 6.57 | 2.42 | 2.39 | |
| n-dodecyl | 0.28 | 0 | 0 | 0 | |
| mercaptan | | | | | |
| de-ionized water | 116.96 | 118.85 | 116.41 | 119.23 | initiator solution |
| potassium persulfate | 4.76 | 4.55 | 4.74 | 0 | |
| ammonium | 0 | 0 | 0 | 4.69 | |
| persulfate | | | | | |
| Acticide LA | 1.17 | 2.52 | 2.42 | 2.39 | biocide |
| de-ionized water | 52.80 | 46.74 | 45.62 | 45.17 | rinsing |
| TOTAL | 2500.00 | 2500.00 | 2500.00 | 2500.00 | |

A reactor equipped with a stirrer, heat source and nitrogen inlet is purged with nitrogen and charged with water, then heated to 78° C. Potassium persulfate or ammonium persulfate is added to the reactor, and the reactor contents are mixed for five minutes. Thereafter, the pre-emulsion mixture is fed into the reactor over a 230 minute period. The temperature of the reactor batch is allowed to rise to 79-81° C. and then maintained at that temperature throughout the polymerization reaction. An initiator solution feed is commenced after the pre-emulsion feed begins. Twenty-five minutes after the pre-emulsion feed is complete, the initiator feed is complete and the reactor contents are held at 79-81° C. for 60 minutes. The reactor contents are then allowed to cool, and when the temperature reaches 38° C., a biocide is added. The rinse water is used throughout the process to wash out the various feed vessels and lines, and to rinse the reactor at the end of the polymerization. Base Polymer A has a solids content of about 66% and a pH of 1.8.

### Preparation of Pressure Sensitive Adhesive

### Examples 1-8

Using the Base Polymers described above, a series of pressure sensitive adhesive compositions are prepared by compounding the base polymer and neutralizing it with a hydroxy functional amine or blend thereof. In several examples, a salt from an organic acid is used.

Table 3 identifies the neutralizing agent, and the salt, if any, used to produce the adhesive compositions of Examples 1-8 and Comparative Example A. Examples 1-7 are prepared using Base Polymer A. Example 8 is prepared using Base Polymer B. Comparative Example A is Base Polymer A neutralized with ammonia and is referenced for comparison in Example 16 below. The amount of neutralizing agent and salt listed is in parts by weight per 100 parts dry polymer.

The abbreviations used below are as follows:

Bis Tris Methane 2-[bis-(2-hydroxyethyl)-amino]-2-hydroxymethyl propane-1,3-diol

TEA triethanolamine

Trizma 2-amino-2-(hydroxymethyl)-1,3-propanediol

NMDG N-methyl-D-glucamine

H EEDA N,N,N′,N′-tetrakis-(2-hydroxyethyl)-ethylenediamine

HPEDA N,N,N′,N′-tetrakis-(2-hydroxypropyl)-ethylenediamine

Na-Cit sodium citrate dihydrate

Na-Glu sodium gluconate

ammonia 12% ammonia

TABLE 3

| | | |
|---|---|---|
| Example | Neutralizing Agent(s) | Salt |

| | | | | |
|---|---|---|---|---|
| 1 | Bis Tris Methane | 3.24 | Na-Cit | 2.98 |
| 2 | Bis Tris Methane | 1.52 | Na-Cit | 2.98 |
| | TEA | 3.30 | | |
| 3 | Trizma | 1.52 | — | — |
| 4 | Trizma | 2.28 | — | — |
| 5 | Trizma | 1.52 | Na-Cit | 2.98 |
| 6 | NMDG | 2.02 | — | — |
| 7 | NMDG | 2.53 | Na-Glu | 1.49 |
| 8 | NMDG | 1.59 | — | — |
| Comp. A | Ammonia | 0.70 | — | — |

### Preparation of Pressure Sensitive Adhesive

### Examples 9-12

Using Base Polymer A, pressure sensitive adhesive compositions are prepared substantially in accordance with the procedure of Example 1 with the exception that varying amounts of a carbodiimide crosslinker (Carbodilite E-02 from Nisshinbo Industries) is used.

### Preparation of Pressure Sensitive Adhesives

### Examples 13-15

Example 13 is prepared substantially in accordance with the procedure of Example 1, with the exception that Base Polymer C is used. Examples 14, 15, and 16 are prepared substantially in accordance with the procedure of Example 1, with the exception that Base Polymer D is used. Base Polymers C and D both include an organic acid in the polymerization pre-emulsion. Neutralizing agents were added as set forth in Table 4 as parts per 100 parts of dry polymer.

TABLE 4

| | |
|---|---|
| Example | Neutralizing Agent(s) |

| | | |
|---|---|---|
| 13 | Bis Tris Methane | 2.94 |
| | TEA | 3.30 |
| 14 | Bis Tris Methane | 2.94 |
| | TEA | 3.30 |
| 15 | HEEDA | 3.20 |
| | TEA | 2.89 |
| 16 | HPEDA | 9.20 |

In some embodiments, processes of the present disclosure may be used upon any label that undergoes a dimensional change upon exposure to high temperatures and/or has a reduced peel adhesion upon exposure to high temperatures. In some embodiments, a dimensional change may result, in whole or in part, from the shrinkage or expansion of a label, or a layer or layers of a label, upon exposure to high temperatures. Any suitable amount of dimensional change is contemplated by some embodiments of the present disclosure. In some embodiments, labels or layers of labels having a dimensional change in the range of about 0.5% to about 1%, such as for expansion films, or 5% to about 70% in other embodiments may be used and upon exposure to heat, hot liquid, or hot gas for sufficient time the label may be removed from a material using processes of the present disclosure. By way of further example, labels comprised of high modulus films may also be removed using embodiments of the present disclosure. In some embodiments, labels may have a degree of water sensitivity for embodiments in which hot water or steam is employed in a label removal process.

Curling Labels:

As indicated above, processes of the present disclosure for removing labels may be used in connection any suitable label. By way of example and as indicated above, processes of the present disclosure may be used, in some specific embodiments, to remove a label that undergoes a dimensional change upon exposure to high temperatures and/or that has a reduced peel adhesion upon exposure to high temperatures. In some embodiments, a dimensional change may result, in whole or in part, from the shrinkage or expansion of a label, or a layer or layers of a label, upon exposure to high temperatures.

For example, in some embodiments, a label that may be removed using a process of the present disclosure may include (a) a first polymeric layer having a first coefficient of thermal expansion; (b) a second polymeric layer having a second coefficient of thermal expansion underlying the first polymeric layer, wherein the first coefficient of thermal expansion is less than the second coefficient of thermal expansion; and (c) an adhesive layer underlying the second polymeric layer, wherein the label is reversibly curled toward the first polymeric layer at a certain temperature, such as at or above 50° C.

As used herein, the term “overlies” and cognate terms such a overlying and the like, when referring to the relationship of one or a first layer relative to another or a second layer, refer to the fact that the first layer partially or completely overlies the second layer. The first layer overlying the second layer may or may not be in contact with the second layer. For example, one or more additional layers may be positioned between the first and the second layer. The term “underlies” and cognate terms such as “underlying” and the like have similar meanings except that the first layer partially or completely lies under, rather than over the second layer.

The term “transparent” when referring to one or more layers of the label means any material beneath such layers can be seen through such layers. In reference to the use of the “transparent” or “clear” labels applied to clear containers, such as beer bottles, the bottle and the beer within the bottle are visible through the label.

The term “clear” when referring to one or more layers of the label or to the label itself means the opacity of the layers or label is less than about 5%, and the layers or the label has a haze of less than about 10%. Opacity is measured in accordance with TAPPI Test T425 os, and haze is measured in accordance with ASTM Test Method D-1003.

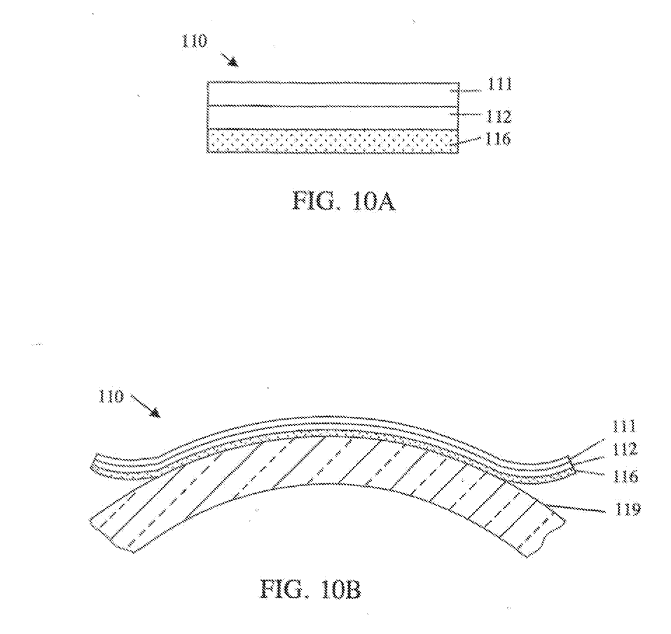

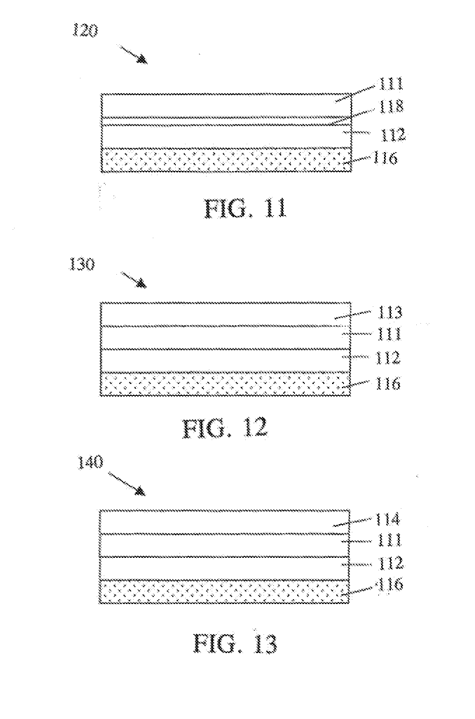

As illustrated in FIG. 10A, label 110 comprises a first polymeric layer 111, a second polymeric layer 112 underlying polymeric layer 111, and adhesive layer 116 underlying the second polymeric layer 112. At sufficient temperatures, e.g., at or above 50° C., the second polymeric layer 112 with the higher coefficient of thermal expansion will expand to a greater degree than the first polymeric layer 111 having the lower coefficient of thermal expansion. The greater expansion of the layer 112 causes the label to curl toward layer 111. The deformation or curl of the label is reversible and the label will revert to its original shape at room temperature. The degree of curl is a function of the film thickness, Youngs modulus and coefficient of linear thermal expansion of the polymeric layers.

FIG. 10B shows the label of FIG. 10A bonded to the curved surface of a cylindrical container 119. In this embodiment, the main curl direction of the label extends in the circumferential direction of the container. As the container is exposed to heat, such as the hot washing liquid used in the bottling industry, the label curls toward the upper layer 111. In one embodiment, the adhesive of adhesive layer 116 possesses a lower peel adhesion at higher temperatures than at ambient or room temperature and will pull away from the surface of the container. In one embodiment, the washing liquid, may act to dissolve or chemically attack the adhesive, allowing the label to pull away from the container. As the label curls, the adhesive is exposed to a greater extent to the hot washing liquid and will eventually be completely removed from the container. Using processes of the present disclosure, labels may be removed from materials, articles, or containers that are flat, cylindrical, or having any other in shape.

Polymeric layers 111 and 112 may be coextruded films. Alternatively, as shown in FIG. 11, the label 120 may comprise a laminated structure wherein polymeric layer 111 is bonded to polymeric layer 112 by lamination adhesive 118. In one embodiment, polymeric layers 111 and 112 are heat sealed together.

The adhesive labels of the disclosure may, and generally do contain other layers. For example, as shown in FIG. 12, the label 130 may contain a metal layer 113 which overlies and is in contact with first polymeric layer 111. Alternatively, a print layer 114 can be on the upper surface of polymeric layer 111 as illustrated in FIG. 13.

In one embodiment, one of polymeric layers of the label comprises a polymeric ink layer. For example, the first polymeric layer 111 may comprise a crosslinked ink that has been screen printed onto the second polymeric layer 112. Alternatively, the second polymeric layer 112 may comprise an ink layer that has been printed onto the first polymeric layer 111.

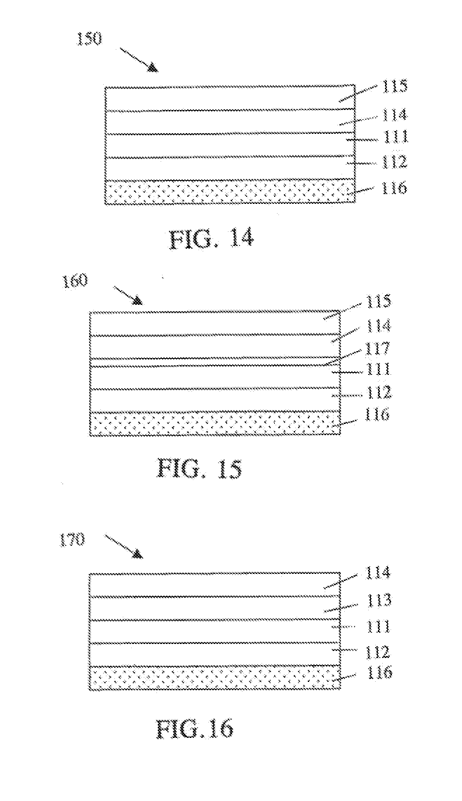

FIG. 14 illustrates label 150 which comprises first polymeric layer 111, second polymeric layer 112 underlying first polymeric layer 111, adhesive layer 116 underlying second polymeric layer 112, print layer 114 overlying first polymeric layer 111 and transparent protective layer 115 which overlies and is in contact with the upper surface of the print layer 114.

FIG. 15 illustrates label 160 which is similar to the label of FIG. 14, except that label 160 contains an additional antistatic polymer layer 117 between the print layer 114 and the first polymeric layer 111.

Some labels may also contain adhesion promoting layers between one or more of the layers shown. For example, an adhesion promoting layer can be inserted between the second polymeric layer 112 and the adhesive layer 116; between the first polymeric layer 111 and the metal layer 113 or the print layer 114; etc.

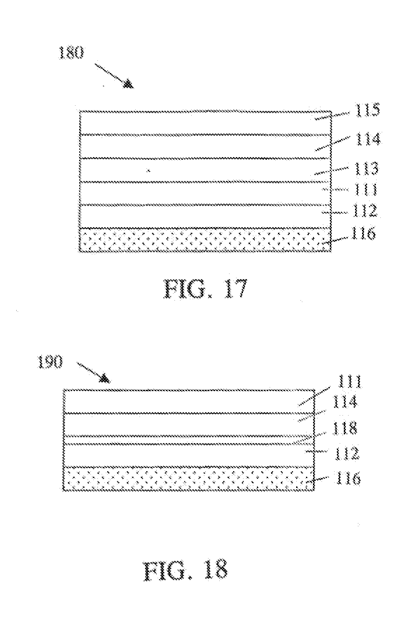

In another embodiment, a label that may be used in accordance with the present disclosure comprises: (a) a first polymeric layer having a first coefficient of thermal expansion; (b) a second polymeric layer having a second coefficient of thermal expansion underlying the first polymeric layer, wherein the first coefficient of thermal expansion is less than the second coefficient of thermal expansion; (c) an adhesive layer underlying the second polymeric layer; (d) a metal layer overlying the first polymeric layer; and (e) a print layer overlying the metal layer; wherein the label is reversibly curled toward the first polymeric layer at a certain temperature, such as, for example, at or above 50° C. Labels of this embodiment are illustrated in FIGS. 16 and 17. In FIG. 16, label 170 comprises first polymeric layer 111, second polymeric layer 112 underlying first polymeric layer 111 and adhesive layer 16 underlying second polymeric layer 112. Metal layer 113 overlies first polymeric layer 111 and print layer 114 overlies metal layer 113. In FIG. 17, label 180 is similar to the label of FIG. 16 with the addition of transparent protective layer 115 overlying and in contact with print layer 114.

In another embodiment, illustrated in FIG. 18, the label 190 comprises a first polymeric layer 111 having an upper surface and a lower surface, a print layer 114 on the lower surface of the first polymeric layer 111. The first polymeric layer 111 with print layer 114 thereon is bonded to the second polymeric layer 112 by a lamination adhesive 118. An adhesive layer 116 is adhered to the lower surface of the second polymeric layer 112.

Polymeric layers 111 and 112 have different coefficients of thermal expansion. In an expanded state at high temperature, the layer having the higher coefficient of thermal expansion expands to curl the multilayer structure toward the layer having the lower coefficient of thermal expansion. The curl is reversible as the temperature is lowered to room or ambient temperature.

The coefficient of thermal expansion is determined by the equation:

Coefficient of Linear Thermal Expansion(%)=[(B−A)/A]×100

where A and B represent the measured length (cm) of a specimen of a resin after standing at 0° C. and 50° C., respectively, for 2 minutes, the specimen being 1 cm in width, 4.5 cm in length, and not more than 0.5 cm in thickness as prepared at room temperature.

When subjected to the higher temperature, such as that of the wash liquid, the label will curl and be removed from the underlying substrate to which it is adhered provided the curl force of the label (F_{Label}) is greater than the peel adhesion of the label to the underlying substrate (E_{PA}):

F_{Label}>F_{PA}

The curl force of the label, F_{La}bei, can be determined using the following equation:

F_{Label}=(α₂−α₁)(T−T₀)(⅛t)(E₁E₂/(E₁+E₂))

wherein α₂ is the coefficient of linear thermal expansion of the bottom layer (polymeric layer 12); α₁ is the coefficient of linear thermal expansion of the top layer (polymeric layer 11); T is the temperature of the washing liquid, T₀ is the temperature at which the label is made, typically, room temperature (23° C.); t is the total thickness of the label; E₁ is the modulus of elasticity of the top layer (polymeric layer 11) and E₂ is the modulus of elasticity of the bottom layer (polymeric layer 12).

In one embodiment, the difference between the coefficient of linear thermal expansion of the bottom layer and that of the top layer, (α₂−α₁), is greater than or equal to about 3×10⁻⁵ (1/° C.). In one embodiment, α₂−α₁ is about 7×10⁻⁵ (1/° C.).

The polymeric layers useful in the present disclosure do not exhibit heat shrinkage beyond the typically accepted limits of heat stable pressure sensitive adhesive films, e.g., <1% at 70° and <2% at 100° C. In one embodiment, the polymeric layer 111 has a heat shrinkage of less than 4% at 80° C.

Each of the polymeric layers 111 and 112 may be a monolayer film or a multilayer film. The multilayer film may comprise from two to ten or more layers. Depending on the end use of the label, the polymeric layers may be transparent or opaque. Opaque polymeric layers generally comprise a polymer as described below and one or more pigments to provide the polymeric layer, or one layer of a multilayer polymeric film with the desired color. Pigments useful for this purpose are well known in the art. For example, white films can be prepared by introducing titanium dioxide and other white pigments into the polymer. Carbon black may be introduced to provide a black or grey film.

In one embodiment, polymeric layer 111 and polymeric layer 112 are laminated together. Polymeric layer 112 may comprise a coextruded film or may comprise a monolayer film. Polymeric layer 111 may comprise a coextruded film or may comprise a monolayer film. Polymeric layers 111 and 112 may have a different coefficient of linear thermal expansion in the machine direction (MD) and have a very low coefficient of linear thermal expansion in the cross direction (CD) when the curl is in the machine direction of the label. Alternatively, when the curl is in the cross direction of the label, the polymeric layers 111 and 112 have different coefficient of linear thermal expansion in the CD and have a very low coefficient of linear thermal expansion in the MD. The difference in the coefficient of thermal expansion can be obtained by using different polymeric materials, for example polyethylene for polymeric layer 112 and polyethylene terephthalate for polymeric layer 111. Alternatively, the difference in coefficient of thermal expansion can be obtained by differences in molecular orientation. For example, a cross direction (trans direction) oriented film for polymer layer 111 and a machine direction oriented film for polymer layer 112.

In one embodiment, polymeric layers 111 and 112 are coextruded. For example polymeric layers 111 and 112 may comprise a polypropylene/ethylene vinyl acetate coextrudate; a polyacrylate/polyethylene coextrudate; or a polyacrylate/ethylene vinyl alcohol coextrudate. Many other coextruded combinations are possible, including coextrudates comprising more than two layers.

A wide variety of polymer film materials are useful in preparing the polymeric layers of labels that may be removed using processes of the present disclosure. For example, the polymer film material may include polymers and copolymers such as at least one polyolefin, polyacrylate, polystyrene, polyamide, polyvinyl alcohol, poly(alkylene acrylate), poly(ethylene vinyl alcohol), poly(alkylene vinyl acetate), polyurethane, polyacrylonitrile, polyester, polyester copolymer, fluoropolymer, polysulfone, polycarbonate, styrene-maleic anhydride copolymer, styrene-acrylonitrile copolymer, ionomers based on sodium or zinc salts of ethylene methacrylic acid, cellulosics, polyacrylonitrile, alkylene-vinyl acetate copolymer, or mixtures of two or more thereof.

The polyolefins which can be utilized as the polymer film material include polymers and copolymers of olefin monomers containing 2 to about 12 carbon atoms such as ethylene, propylene, 1-butene, etc., or blends of mixtures of such polymers and copolymers. In one embodiment the polyolefins comprise polymers and copolymers of ethylene and propylene. In another embodiment, the polyolefins comprise propylene homopolymers, and copolymers such as propylene-ethylene and propylene-1-butene copolymers. Blends of polypropylene and polyethylene with each other, or blends of either or both of them with polypropylene-polyethylene copolymer also are useful. In another embodiment, the polyolefin film materials are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content. Useful propylene homopolymers and copolymers are described in U.S. Pat. No. 5,709,937 (Adams et al). The copolymers include propylene-ethylene copolymers containing up to about 10% by weight of ethylene, and propylene-1-butene copolymers containing up to about 15% by weight of 1-butene. Oriented films described in the '937 patent are clear films useful as the polymeric layers in the labels. The disclosure of U.S. Pat. No. 5,709,937 is hereby incorporated by reference.

Various polyethylenes can be utilized as the polymer film material including low, medium, and high density polyethylenes, and mixtures thereof. An example of a useful low density polyethylene (LDPE) is Rexene 1017 available from Huntsman. An example of a useful high density polyethylene (HDPE) is Formoline LH5206 available from Formosa Plastics. In one embodiment the polymer film material comprises a blend of 80 to 90% HDPE and 10-20% of LDPE.

The propylene homopolymers which can be utilized as the polymer film material in the disclosure, either alone, or in combination with a propylene copolymer as described herein, include a variety of propylene homopolymers such as those having melt flow rates (MFR) from about 0.5 to about 20 as determined by ASTM Test D 1238. In one embodiment, propylene homopolymers having MFR's of less than 10, and more often from about 4 to about 10 are particularly useful. Useful propylene homopolymers also may be characterized as having densities in the range of from about 0.88 to about 0.92 g/cm³. A number of useful propylene homopolymers are available commercially from a variety of sources, and some useful polymers include: 5A97, available from Dow Chemical and having a melt flow of 12.0 g/10 min and a density of 0.90 g/cm³; DX5E66, also available from Dow Chemical and having an MFI of 8.8 g/10 min and a density of 0.90 g/cm³; and WRDS-1057 from Dow Chemical having an MFI of 3.9 g/10 min and a density of 0.90 g/cm³. Useful commercial propylene homopolymers are also available from Fina and Montel.

Examples of useful polyamide resins include resins available from EMS American Grilon Inc., Sumter, S.C. under the general tradename Grivory such as CF6S, CR-9, XE3303 and G-21. Grivory G-21 is an amorphous nylon copolymer having a glass transition temperature of 125° C., a melt flow index (DIN 53735) of 90 ml/10 min and an elongation at break (ASTM D638) of 15. Grivory CF65 is a nylon 6/12 film grade resin having a melting point of 135DC, a melt flow index of 50 ml/10 min, and an elongation at break in excess of 350%. Grilon CR9 is another nylon 6/12 film grade resin having a melting point of 200° C., a melt flow index of 200 ml/10 min, and an elongation at break at 250%. Grilon XE 3303 is a nylon 6.6/6.10 film grade resin having a melting point of 200° C., a melt flow index of 60 ml/10 min, and an elongation at break of 100%. Other useful polyamide resins include those commercially available from, for example, International Paper of Wayne, N.J. under the Uni-Rez product line, and dimer-based polyamide resins available from Bostik, International Paper, Fuller, Henkel (under the Versamid product line). Other suitable polyamides include those produced by condensing dimerized vegetable acids with hexamethylene diamine. Examples of polyamides available from International Paper include Uni-Rez 2665; Uni-Rez 2620; Uni-Rez 2623; and Uni-Rez 2695.

Polystyrenes can also be utilized as the polymeric film material and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillips Petroleum Co. KR-10 is believed to be a copolymer of styrene with 1,3-butadiene.

Polyurethanes also can be utilized as the polymer film material, and the polyurethanes may include aliphatic as well as aromatic polyurethanes. The polyurethanes are typically the reaction products of (A) a polyisocyanate having at least two isocyanate (—NCO) functionalities per molecule with (B) at least one isocyanate reactive group such as a polyol having at least two hydroxy groups or an amine. Suitable polyisocyanates include diisocyanate monomers, and oligomers.

Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of commercial polyurethanes include Sancure 2710® and/or Avalure UR 445® (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 878®, Sancure 815®, Sancure 1301®, Sancure 2715®, Sancure 1828®, Sancure 2026®, and Sancure 12471® (all of which are commercially available from Noveon, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Avecia, formerly Avecia Resins), NeoRez R-940 (Avecia), and NeoRez R-960 (Avecia).

Examples of such aliphatic polyether polyurethanes include Sancure 2710® and/or Avalure UR 445®, Sancure 878®, NeoRez R-600, NeoRez R-966, NeoRez R-967, and Witcobond W-320.

In one embodiment, one of the polymeric layers comprises at least one polyester polyurethane. Examples of these urethanes include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company Avecia, and the acrylic copolymer dispersion sold under the name “Neocryl XK-90” by the company Avecia.

Polyesters prepared from various glycols or polyols and one or more aliphatic or aromatic carboxylic acids also are useful film materials. Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from duPont is Selar PT-8307 which is polyethylene terephthalate.

Acrylate polymers and copolymers and alkylene vinyl acetate resins (e.g., EVA polymers) also are useful as the film forming materials in the preparation of the constructions of the disclosure. Commercial examples of available polymers include Escorene UL-7520 (Exxon), a copolymer of ethylene with 19.3% vinyl acetate; Nucrell 699 (duPont), an ethylene copolymer containing 11% of methacrylic acid, etc.

Ionomers (polyolefins containing ionic bonding of molecular chains) also are useful. Examples of ionomers include ionomeric ethylene copolymers such as Surlyn 1706 (duPont) which is believed to contain interchain ionic bonds based on a zinc salt of ethylene methacrylic acid copolymer. Surlyn 1702 from duPont also is a useful ionomer.

Polycarbonates also are useful, and these are available from the Dow Chemical Co. (Calibre) G. E. Plastics (Lexan) and Bayer (Makrolon). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range of from 4 to 22 g/10 min.

In one embodiment, one of the polymeric layers may comprise fluorinated polymer. The fluorinated polymer includes a thermoplastic fluorocarbon such as polyvinylidene fluoride (PVDF). The fluorinated polymer also can include copolymers and terpolymers of vinylidene fluoride. A useful thermoplastic fluorocarbon is the polyvinylidene fluoride known as Kynar, a trademark of Pennwalt Corp. This polymer is a high molecular weight (400,000) polymer which provides a useful blend of durability and chemical resistance properties. Generally, a high molecular weight PVDF resin, with a weight average molecular weight of about 200,000 to about 600,000 is used.

The polymeric film material may be free of inorganic fillers and/or pigments for clear films and clear labels, or the polymeric film material may be cavitated and/or contain inorganic fillers and other organic or inorganic additives to provide desired properties such as appearance properties (opaque or colored films), durability and processing characteristics. Nucleating agents can be added to increase crystallinity and thereby increase stiffness. Examples of useful materials include calcium carbonate, titanium dioxide, metal particles, fibers, flame retardants, antioxidant compounds, heat stabilizers, light stabilizers, ultraviolet light stabilizers, antiblocking agents, processing aids, acid acceptors, etc. Opaque and/or white polymeric films are often utilized when the labels described herein do not contain a metal layer overlying the outer polymeric layer.

The polymer film material may be chosen to provide a continuous polymer film in the film structures with the desired properties such as improved tensile strength, elongation, impact strength, tear resistance, and optics (haze and gloss). The choice of polymeric film forming material also is determined by its physical properties such as melt viscosity, high speed tensile strength, percent elongation etc. In one embodiment, clear or transparent polymeric films are used in the label construction when clear or transparent labels are desired.

In some embodiments, the thickness of the each polymeric layer is at least 5 microns, or at least 15 microns. The total thickness of the label film is from about 2.5 microns to about 250 microns, or from about 25 to about 125 microns. In one embodiment the total thickness of the label film is from about 25 to about 75 microns. Each polymeric layer may comprise a single layer, or can be a multilayer film of two or more adjacent layers. For example the polymeric layer can comprise one layer of a polyolefin and one layer of a blend of a polyolefin and a copolymer of ethylene and vinyl acetate (EVA). In another embodiment the polymeric layer comprises three layers, a base or core layer of, for example, a polyolefin, and skin layers in both sides of the base or core layer which may be comprised of the same or different polymer blends. The individual layers of a multilayer film may be selected to provide desirable properties.

The polymeric films useful in the labels herein can be manufactured by those processes known to those skilled in the art such as by casting or extrusion. In one embodiment, the films are manufactured by polymer extrusion or coextrusion processes. The extrudate or coextrudate of polymeric film materials is formed by simultaneous extrusion from a suitable known type of extrusion or co-extrusion die, and in the case of a coextrudate, the layers are adhered to each other in a permanently combined state to provide a unitary coextrudate.

In addition to coextrusion, some multilayer films useful in the present disclosure may be prepared by extrusion of a continuous film to form one layer followed by the application of one or more additional layers on the extruded layer by extrusion of one or more additional layers; by lamination of a preformed polymer film to a preformed functional film; or by deposition of additional layers on the preformed film from an emulsion or solution of a polymeric film forming material.

In one embodiment, polymeric films used in the present disclosure are not oriented. That is, the films are not subjected to a hot-stretching and annealing step. In other embodiments, the films contained in the labels used in the present disclosure may be oriented in the machine direction (uniaxially) or in both the machine and cross directions (biaxially) by hot-stretching and annealing by techniques well known to those skilled in the art. For example, the films may be hot-stretched in the machine direction only at a ratio of at least 2:1 and more often, at a ratio of between about 2:1 to about 9:1. After the film has been hot stretched, it is generally passed over annealing rolls where the film is annealed or heat-set at temperatures in the range of from about 50° C., more often 100° C. to about 150° C., followed by cooling. In another embodiment, the polymeric film is a biaxially oriented.

It may be desirable that the films exhibit a degree of stiffness in the machine direction and the cross direction to facilitate handling, printing and dispensing. Thus, in one embodiment, the stiffness in the machine direction, and the cross direction should be at least about 14 Gurley (mg), as determined using TAPPI Test T543 pm and in a further embodiment the Gurley stiffnesses in both directions are within about 5 Gurley units (sometimes referred to as a balanced stiffness).

Polymer films useful in the labels are available commercially from a variety of sources such as Avery Dennison Corp., Painesville, Ohio; AMTOPP, a division of Interplast Group LTD, Livingston, N.J. 07039, Exxon Mobil Chemical Co., Macdon, N.Y. 14502; AET Films, New Castle, Del. 19720; and UCB Films Inc., Smyrna, Ga. 30080. Clear films and white films are available.

The surface energy of the surfaces of the polymeric films can be enhanced by treatments such as corona discharge, flame, plasma, etc. to provide the surfaces with desirable properties such as improved adhesion to subsequently applied layers. Procedures for corona treating and flame treating of polymer films are well known to those skilled in the art. In one embodiment, a polymeric film is corona discharge treated on the upper surface and flame treated on the lower surface.

In one embodiment of the disclosure, polymeric layer 111 comprises a polyethylene terephthalate (PET) film laminated to polymeric layer 112 which comprises a biaxially oriented polypropylene (BOPP) film.

As noted above, some labels that may be removed using processes of the present disclosure may also comprise a metal layer 113 overlying the first polymeric layer 111. In one embodiment, the metal layer is in contact with and is adhered to the upper surface of the first polymeric layer 111 which may have been previously corona treated or flame treated. The metal may be applied to the polymeric layer by any known methods such as electroplating, sputtering, vacuum metalizing, printing, etc. Chemical primers or other adhesion promoting compositions may in some instances, be applied to the surface of the polymeric layer to increase the adhesion of the metal to the polymeric layer.

The metal of the metal layer may be any of a number of metals, including tin, chromium, nickel, stainless steel, copper, aluminum, indium, gold, silver, and alloys of one or more thereof. Useful metallized films are available commercially.

Although not shown in FIGS. 10-18, the labels of the present disclosure may also contain a layer of an ink-receptive composition on the polymeric layer 111 or the metal layer 113 that enhances the printability of the polymeric layer or metal layer, and the quality of the print layer thus obtained. A variety of such compositions are known in the art, and these compositions generally include a binder and a pigment, such as silica or talc, dispersed in the binder. The presence of the pigment decreases the drying time of some inks. Such ink-receptive compositions are described in U.S. Pat. No. 6,153,288 (Shih et al) and the disclosure of this patent is hereby incorporated by reference.

The labels the present disclosure may, and generally do, comprise one or more print layers. In one embodiment, illustrated in FIGS. 16 and 17, a print layer 114 is adhered to the upper surface of the metal layer 113. In the embodiment illustrated in FIGS. 113 and 114, the print layer 114 is in contact with the upper surface of the first polymeric layer 111.

The print layer may be an ink or graphics layer, and the print layer may be a mono-colored or multi-colored print layer depending on the printed message and/or the intended pictorial design. These include, variable imprinted data such as serial numbers, bar codes, trademarks, etc. The thickness of the print layer is typically in the range of about 0.5 to about 10 microns, and in one embodiment about 1 to about 5 microns, and in another embodiment about 3 microns. The inks used in the print layer include commercially available water-based, solvent-based or radiation-curable inks. Examples of these inks include Sun Sheen (a product of Sun Chemical identified as an alcohol dilutable polyamide ink), Suntex MP (a product of Sun Chemical identified as a solvent-based ink formulated for surface printing acrylic coated substrates, PVDC coated substrates and polyolefin films), X-Cel (a product of Water Ink Technologies identified as a water-based film ink for printing film substrates), Uvilith AR-109 Rubine Red (a product of Daw Ink identified as a UV ink) and CLA91598F (a product of Sun Chemical identified as a multibond black solvent-based ink).

In one embodiment, the print layer comprises a polyester/vinyl ink, a polyamide ink, an acrylic ink and/or a polyester ink. The print layer is formed in the conventional manner by depositing, by gravure printing or the like, an ink composition comprising a resin of the type described above, a suitable pigment or dye and one or more suitable volatile solvents onto one or more desired areas of the metal layer. After application of the ink composition, the volatile solvent component(s) of the ink composition evaporate(s), leaving only the non-volatile ink components to form the print layer. An example of a suitable resin for use in forming a polyester ink is ViTEL® 2700 (Bostik-Findley)—a copolyester resin having a high tensile strength (7000 psi) and a low elongation (4% elongation). A ViTEL® 2700-based polyester ink composition may comprise 18% ViTEL® 2700, 6% pigment, 30.4% n-propyl acetate (NP Ac) and 45.6% toluene. As can readily be appreciated, ViTEL® 2700 is, by no means, the only polyester resin that may be used to formulate a polyester ink, and solvent systems, other than an NP Ac/toluene system, may be suitable for use with ViTEL® 2700, as well as with other polyester resins. An example of a polyester adhesive composition comprises 10.70%, by weight, ViTEL® 2300 polyester resin; 10.70%, by weight, ViTEL® 2700 polyester resin; 1.1%, by weight, BENZOFLEX 5404 plasticizer; 1.1%, by weight, HULS 512 adhesion promoter; 19.20%, by weight, toluene; and 57.10%, by weight, methyl ethyl ketone.

The adhesion of the ink to the surface of the metal layer can be improved, if necessary, by techniques well known to those skilled in the art. For example, as mentioned above, an ink primer or other ink adhesion promoter can be applied to the metal layer or the polymeric film layer before application of the ink. Alternatively the surface of the polymeric film can be corona treated or flame treated to improve the adhesion of the ink to the polymeric film layer.

Useful ink primers may be transparent or opaque and the primers may be solvent based or water-based. In one embodiment, the primers are radiation curable (e.g., UV). The ink primer is typically comprised of a lacquer and a diluent. The lacquer is typically comprised of one or more polyolefins, polyamides, polyesters, polyester copolymers, polyurethanes, polysulfones, polyvinylidine chloride, styrene-maleic anhydride copolymers, styrene-acrylonitrile copolymers, ionomers based on sodium or zinc salts or ethylene methacrylic acid, polymethyl methacrylates, acrylic polymers and copolymers, polycarbonates, polyacrylonitriles, ethylene-vinyl acetate copolymers, and mixtures of two or more thereof. Examples of the diluents that can be used include alcohols such as ethanol, isopropanol and butanol; esters such as ethyl acetate, propyl acetate and butyl acetate; aromatic hydrocarbons such as toluene and xylene; ketones such as acetone and methyl ethyl ketone; aliphatic hydrocarbons such as heptane; and mixtures thereof. The ratio of lacquer to diluent is dependent on the viscosity required for application of the ink primer, the selection of such viscosity being within the skill of the art. An example of a ink primer material that can be used is CLB04275F-Prokote Primer (a product of Sun Chemical Corporation identified as a solvent based primer useful with inks and coatings). The ink primer layer may have a thickness of from about 1 to about 4 microns or from about 1.5 to about 3 microns.

A transparent polymer protective topcoat or overcoat layer may be present in the labels of the disclosure. In the embodiments illustrated in FIGS. 14, 15 and 17, a transparent topcoat or overcoat layer 115 overlies the print layer 114. The protective topcoat or overcoat layer provide desirable properties to the label before and after the label is affixed to a substrate such as a container. The presence of a transparent topcoat layer over the print layer may, in some embodiments provide additional properties such as antistatic properties stiffness and/or weatherability, and the topcoat may protect the print layer from, e.g., weather, sun, abrasion, moisture, water, etc. The transparent topcoat layer can enhance the properties of the underlying print layer to provide a glossier and richer image. The protective transparent protective layer may also be designed to be abrasion resistant, radiation resistant (e.g, UV), chemically resistant, thermally resistant thereby protecting the label and, particularly the print layer from degradation from such causes. The protective overcoat may also contain antistatic agents, or anti-block agents to provide for easier handling when the labels are being applied to containers at high speeds. The protective topcoat constructions of the labels used in the disclosure may also be selected to provide labels useful on containers subjected to subsequent liquid processing such as bottle washing/rinsing, filling and pasteurization, or liquid immersion (e.g., ice bath) without displaying adverse consequences such as label lifting or hazing. The protective layer may be applied to the print layer by techniques known to those skilled in the art. The polymer film may be deposited from a solution, applied as a preformed film (laminated to the print layer), etc.

When a transparent topcoat or overcoat layer is present, it may have a single layer or a multilayered structure. The thickness of the protective layer is generally in the range of about 12.5 to about 125 microns, and in one embodiment about 25 to about 75 microns. Examples of the topcoat layers are described in U.S. Pat. No. 6,106,982 which is incorporated herein by reference.

The protective layer may comprise polyolefins, thermoplastic polymers of ethylene and propylene, polyesters, polyurethanes, polyacryls, polymethacryls, vinyl acetate homopolymers, co- or terpolymers, ionomers, and mixtures thereof.

The transparent protective layer may contain UV light absorbers and/or other light stabilizers. Among the UV light absorbers that are useful are the hindered amine absorbers available from Ciba Specialty Chemical under the trade designations “Tinuvin”. The light stabilizers that can be used include the hindered amine light stabilizers available from Ciba Specialty Chemical under the trade designations Tinuvin 111, Tinuvin 123, (bis-(1-octyloxy-2,2,6,6-tetramethyl-4-piperidinyl) sebacate; Tinuvin 622, (a dimethyl succinate polymer with 4-hydroxy-2,2,6,6-tetramethyl-1-piperidniethanol); Tinuvin 770 (bis-(2,2,6,6-tetramethyl-4-piperidinyl)-sebacate); and Tinuvin 783. Also useful light stabilizers are the hindered amine light stabilizers available from Ciba Specialty Chemical under the trade designation “Chemassorb”, especially Chemassorb 119 and Chemassorb 944. The concentration of the UV light absorber and/or light stabilizer is in the range of up to about 2.5% by weight, and in one embodiment about 0.05% to about 1% by weight.

The transparent protective layer may contain an antioxidant. Any antioxidant useful in making thermoplastic films can be used. These include the hindered phenols and the organo phosphites. Examples include those available from Ciba Specialty Chemical under the trade designations Irganox 1010, Irganox 1076 or Irgafos 168. The concentration of the antioxidant in the thermoplastic film composition may be in the range of up to about 2.5% by weight, and in one embodiment about 0.05% to about 1% by weight.

The adhesive layer 16 of the label may comprise a pressure sensitive adhesive (PSA). The PSA may comprise an adhesive that exhibits a drop in peel adhesion at elevated temperatures. In one embodiment, the adhesive comprises an emulsion based adhesive that exhibits a significant reduction in peel adhesion from room temperature to 50° C.

A description of useful pressure sensitive adhesives may be found in Encyclopedia of Polymer Science and Engineering, Vol. 13. Wiley-Interscience Publishers (New York, 1988). Additional description of useful PSAs may be found in Polymer Science and Technology, Vol. 1, Interscience Publishers (New York, 1964). Conventional PSAs, including acrylic-based PSAs, rubber-based PSAs and silicone-based PSAs are useful. The PSA may be a solvent based or may be a water based adhesive. Hot melt adhesives may also be used. In one embodiment, the PSA comprises an acrylic emulsion adhesive.

High Tensile Modulus Labels:

In addition to the previously described curling labels, in other embodiments, exemplary labels that may be removed using processes of the present disclosure may include labels comprising (a) a film having a first surface and a second surface and comprising a first film layer, and (b) an adhesive layer having a first surface and a second surface and comprising an adhesive where the first surface of the adhesive layer is adhesively joined to the second surface of the film, where the first film layer comprises at least one thermoplastic polymer, the first film layer has a tensile modulus (American Society for Testing and Materials, hereinafter “ASTM” D882) in a machine direction and/or a transverse direction of at least 900 MPa after immersion in water for 3 minutes, and the first film layer has an absolute areal dimensional change (ASTM D1204) of less than 5.0% after immersion in water at a temperature of about 80° C. for at least about 3 minutes. In some embodiments if this exemplary label, the thickness of the first film layer is greater than the thickness of the adhesive layer. In still other embodiments, the first film layer has a water absorption (ASTM D570) of less than 2.1% by weight after immersion in water at a temperature of about 80° C. for at least about 2 hours. Such films may be monolayered film or multilayered. In some embodiments, the first film layer comprises two or more layers where each of said two or more layers of the first film layer has a tensile modulus (ASTM D882) in a machine direction and/or a transverse direction of at least 900 MPa after immersion in water at a temperature of about 80° C. for at least about 3 minutes and has an absolute areal dimensional change (ASTM D1204) of less than 4.9% after immersion in water at a temperature of about 80° C. for at least about 3 minutes.

In another exemplary embodiment in which a film comprises a second film layer comprising at least one thermoplastic polymer where the second film layer has a property selected from the group consisting of a tensile modulus (ASTM D882) in a machine direction and a transverse direction below 900 MPa after immersion in water at a temperature of about 80° C. for at least about 3 minutes, an absolute areal dimensional change (ASTM D1204) of at least 4.9% after immersion in water at a temperature of about 80° C. for at least about 3 minutes, and a combination of the two foregoing properties. In some such embodiments, the second film layer comprises two or more layers where each of said two or more layers of the second film layer has a property selected from the group consisting of a tensile modulus (ASTM D882) in a machine direction and a transverse direction below 900 MPa after immersion in water at a temperature of about 80° C. for at least about 3 minutes, an absolute areal dimensional change (ASTM D1204) of at least 4.9% after immersion in water at a temperature of about 80° C. for at least about 3 minutes, and a combination of the two foregoing properties.

In some embodiments of such high modulus films, a label may be affixed to a container in which (i) the label is attached to the container having a vertical axis and a horizontal axis where the second surface of the adhesive layer is adhesively joined to an outer surface of the container, (ii) the machine direction or the transverse direction of the first film layer circumferentially follows the horizontal axis of the container where the machine direction or the transverse direction that circumferentially follows the horizontal axis of the container has a tensile modulus (ASTM D882) of at least 900 MPa after immersion in water at a temperature of about 80° C. for at least about 3 minutes.

In further illustrating high modulus films that may be removed using processes of the current disclosure and with reference to FIG. 22, a label 210, 220, 230, 240 or 250 is shown that, as described hereinbelow, may provide, upon application to a material, high clarity visual aesthetics, abrasion resistance during processing and handling of the material, resistance to any deleterious effects due to moisture during cold storage or a pasteurization process, and removability of the label using processes of the present disclosure

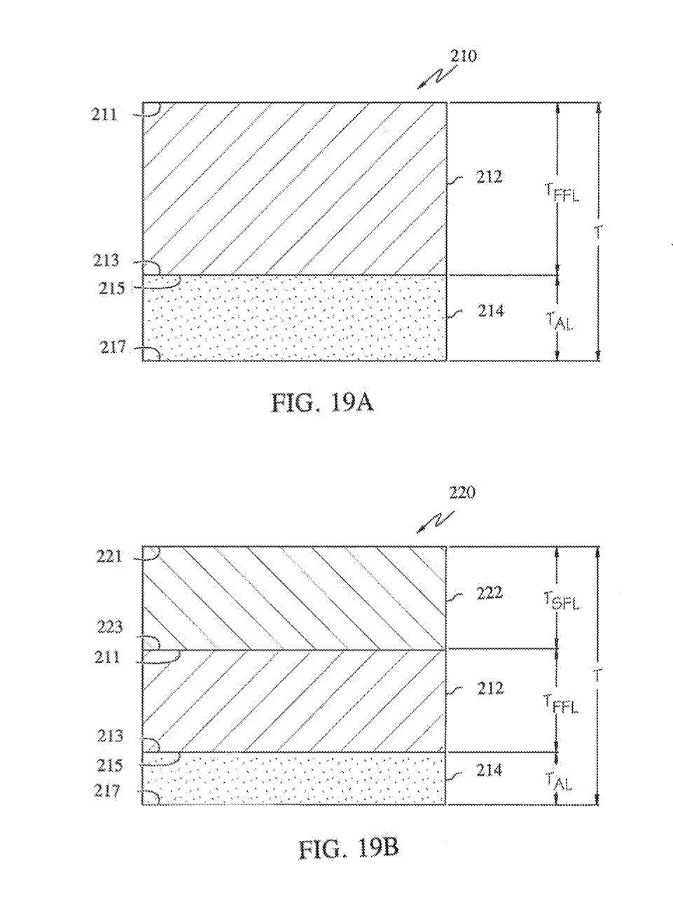

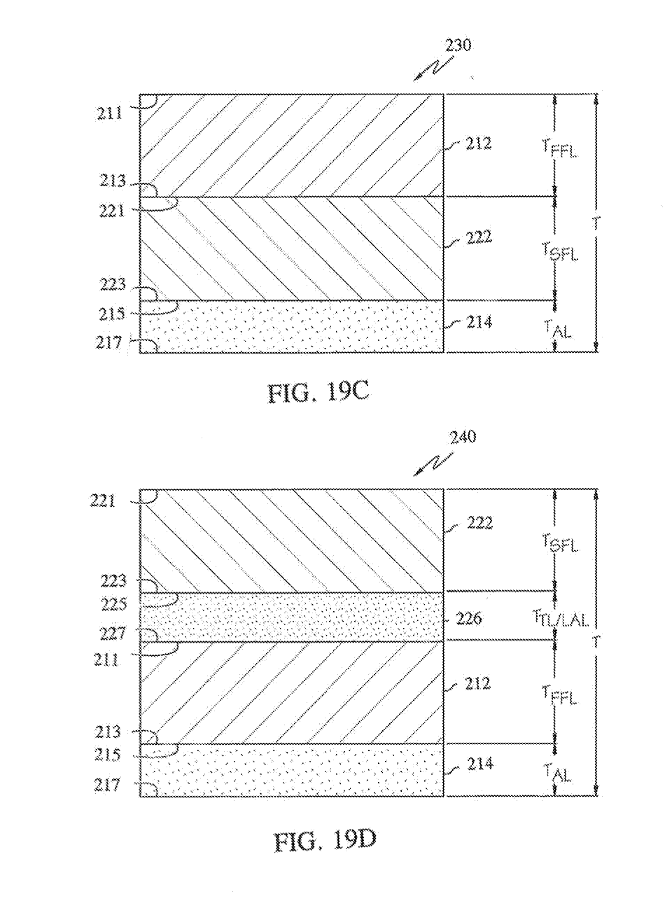

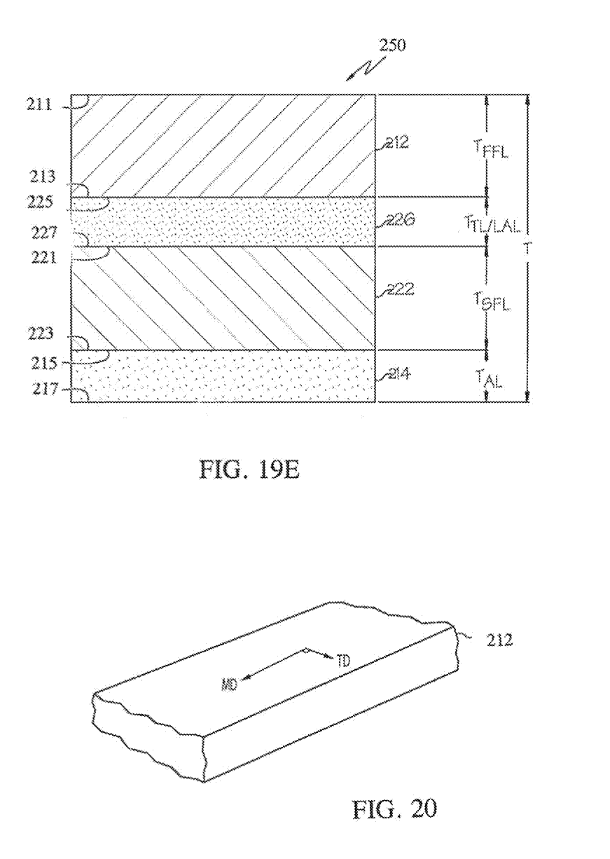

Referring to FIGS. 19A, 19B, 19C, 19D and 19E the labels 210, 220, 230, 240 and 250 of the present disclosure comprise a film that comprises a first film layer 212. The first film layer has a relatively high stiffness in terms of tensile modulus after immersion in warm or hot water. In embodiments the first film layer, after immersion in warm or hot water, has a relatively high stiffness in terms of tensile modulus in a machine direction, in a transverse direction, or in both a machine direction and a transverse direction. In embodiments of the disclosure the first film layer has an has a tensile modulus (ASTM D882) in a machine direction and/or a transverse direction of at least 900 MPa (megapascals), at least 1030 MPa, at least 1160 MPa, or at least 1260 MPa after immersion in water at a temperature of about 80° C. for at least about 3 minutes. Referring to FIG. 20, the first film layer 212 has three directions or dimensions to include a machine direction (MD) and a transverse direction (TD) where the machine direction is the direction that the first film layer is advanced during its manufacture and the transverse direction is the direction that is normal or perpendicular to the machine direction and the machine and transverse directions lie in the largest areal plane of the first film layer. The third direction or dimension of the first film layer is its thickness which is perpendicular to the areal plane containing the machine and transverse directions. The first film layer has a relatively low two-dimensional change in area as measured in the machine direction and the transverse direction after immersion in warm water. In embodiments the first film layer has an absolute areal dimensional change (ASTM D1204) of less than about 5.0%, less than 4.9%, less than 4.2% or less than 3.5% after immersion in water at a temperature of about 80° C. for at least about 3 minutes as measured in the machine direction and the transverse direction. The absolute areal dimensional change can be a shrinkage which results in a reduction in the area or can be an expansion which results in an increase in the area. Referring to FIGS. 19A, 19B and 19C the thickness T_{FFL} of the first film layer is greater than the thickness T_{AL} of an adhesive layer 214 of the label, and in other embodiments the thickness of the first film layer is at least 5% greater, at least 10% greater, at least 20% greater, at least 30% greater, at least 40% greater, at least 50% greater, or at least 60% greater than the thickness of the adhesive layer. The first film layer has a relatively low level of water absorption after immersion in warm water. In embodiments the first film layer has a water absorption (ASTM D570) on a weight basis of less than about 2.1%, less than 1.6%, or less than 1.2% after immersion in water at a temperature of about 80° C. for at least about 2 hours. In other embodiments the first film layer has a water absorption (ASTM D570) on a weight basis of 0.1 to 2%, 0.15 to 1.8%, or 0.2 to 1.6% after immersion in water at a temperature of about 80° C. for at least about 2 hours.

The first film layer comprises at least one thermoplastic polymer. In embodiments the at least one thermoplastic polymer of the first film layer comprises a polymer selected from the group consisting of a polyolefin, a (meth)acrylate polymer, a styrene polymer, a polyester, a halogen-containing polymer, a polycarbonate, a polyacrylonitrile, an aromatic polyether, an aromatic polyimide, an aromatic polyamide-imide, and a mixture of two or more of any of the foregoing polymers. In other embodiments the thermoplastic polymer of the first film layer comprises a polymer selected from the group consisting of an isotactic polypropylene homopolymer, an isotactic polypropylene random copolymer, a poly(alkyl methacrylate), a polystyrene homopolymer, an aromatic polycarboxylic acid based polyester, a polylactic acid, a polycarbonate, an aromatic polyetherketone, an aromatic polyetheretherketone, an aromatic polyether imide, an aromatic polysulfone, an aromatic polyethersulfone, a polyphenylsulfone, an aromatic polyimide, an aromatic polyamide-imide, and a mixture of two or more of any of the foregoing polymers. In other embodiments the thermoplastic polymer of the first film layer comprises a polymer selected from the group consisting of a poly(methyl methacrylate), a polystyrene homopolymer, a polycarbonate, an aromatic polyetherketone, an aromatic polyetheretherketone, an aromatic polyether imide, an aromatic polysulfone, an aromatic polyethersulfone, a polyphenylsulfone, an aromatic polyimide, an aromatic polyamide-imide, and a mixture of two or more of any of the foregoing polymers.

The polyolefin of the first film layer includes homopolymers and copolymers of olefins having 2 to 12 carbon atoms. The polyolefin includes isotactic polypropylene homopolymers having a density of 0.88 to 0.92 g/cm³ and a melt flow rate (ASTM D1238) at 230° C./2.16 kg of 0.5 to 40 g/10 minutes and a melting point of 150 to 170° C., and isotactic polypropylene random copolymers having a density of 0.88 to 0.92 g/cm³ and a melt flow rate (ASTM D1238) at 230° C./2.16 kg of 0.5 to 40 g/10 minutes and a melting point of 125 to 165° C. where the isotactic polypropylene random copolymer can contain on a weight basis 0.1 to 20% or 0.1 to 10% of at least one ethylene or C₄ to C₁₂ olefin comonomer. The polyolefins are generally prepared by a polymerization using a metal based catalyst to include a Ziegler-Natta or metallocene catalyst. Useful polyolefins include for example the isotactic polypropylene homopolymer P4G4K-173X, from Flint Hills Resources of Wichita, Kans., which has a density of 0.9 g/cm³ and a melt flow rate (ASTM D1238) at 230° C./2.16 kg of 12 g/10 minutes, and the isotactic polypropylene random copolymer P5M4K-070X, from Flint Hills Resources, which has a density of 0.9 g/cm³ and a melt flow rate (ASTM D1238) at 230° C./2.16 kg of 10 g/10 minutes and a 3.2% by weight ethylene comonomer content.

The (meth)acrylate polymer of the first film layer includes homopolymers of an alkyl acrylate or of an alkyl methacrylate, copolymers of two or more alkyl acrylates or of two or more alkyl methacrylates where the two or more alkyl acrylates or alkyl methacrylates differ in the number of carbon atoms in the alkyl group, copolymers of one or more alkyl acrylates and one or more alkyl methacrylates, and mixtures of two or more of any of the foregoing polymers. In an embodiment the (meth)acrylate polymer includes homopolymers of an alkyl methacrylate where the alkyl group has 1 to 12 or 1 to 8 or 1 to 4 carbon atoms and the alkyl methacrylate homopolymer has a density of 1.05 to 1.25 g/cm³ and a melt flow rate (ASTM D1238) at 230° C./3.8 kg of 0.5 to 40 g/10 minutes. In an embodiment the (meth)acrylate polymer contains an impact modifier where the impact modifier is a polymeric elastomer which can be derived from an aromatic monomer to include for example styrene-butadiene rubber impact modifiers. The (meth)acrylate polymers are generally prepared by a catalyzed polymerization such as for example by free radical catalysis. Useful (meth)acrylate polymers include alkyl methacrylate homopolymers such as for example the Altuglas® and Plexiglas® poly(methyl methacrylate) resin series manufactured by Arkema Inc. of Philadelphia, Pa., and the Lucite® poly(methyl methacrylate) resin series manufactured by Lucite International of Parkersburg, W. Va.

The styrene polymer of the first film layer includes a homopolymer of styrene or a substituted styrene, a copolymer of styrene or a substituted styrene, or a mixture of two or more of any of the foregoing polymers. A substituted styrene includes a styrene substituted with one or more hydrocarbon groups, such as for example with a methyl group in alpha-methylstyrene, and/or substituted with one or more nonhydrocarbon groups such as for example with a sulfonic acid group in 4-styrenesulfonic acid. The copolymer of styrene or a substituted styrene includes copolymers of styrene or a substituted styrene with one or more monomers where the monomers include olefins, such as for example 1,3-butadiene, as found in for example styrene-butadiene copolymers. In embodiments the styrene polymer is an amorphous atactic polystyrene homopolymer which is prepared by free radical polymerization and has a glass transition temperature of 85 to 105° C. and a density of 1.02 to 1.06 g/cm³ and a melt flow rate (ASTM D1238) at 200° C./5 kg of 0.5 to 40, a crystalline syndiotactic polystyrene homopolymer which is prepared by metallocene catalyzed polymerization and has a melting point of 260 to 280° C., or a mixture of two or more of any of the foregoing polymers. Useful styrene polymers include for example the polystyrene homopolymer resin STYRON® 693, from The Dow Chemical Company of Midland, Mich., which has a specific gravity (ASTM D792) of 1.04 and a melt flow rate (ASTM D1238) at 200° C./5 kg of 3.4 g/10 minutes and a tensile modulus (ASTM D638) of 2882 MPa, and the syndiotactic polystyrene homopolymer Xarec® series from Idemitsu Chemical which is available through Polymer Technology & Services, LLC of Murfreesboro, Tenn.

The polyester of the first film layer includes polymers derived from at least one polycarboxylic acid or derivative thereof, to include ester derivatives, and at least one polyol, or derived from at least one hydroxy-containing carboxylic acid or derivative thereof, to include cyclic lactone derivatives, where the hydroxy-containing carboxylic acid has two or more carbon atoms. The polycarboxylic acid has two or more carbon atoms and two or more carboxylic acid groups. In embodiments the polycarboxylic acid includes a polycarboxylic acid selected from the group consisting of an aliphatic polycarboxylic acid, an aromatic polycarboxylic acid, and a mixture of two more of any of the foregoing polycarboxylic acids. Aromatic polycarboxylic acids include for example terephthalic acid and 2,6-naphthalenedicarboxylic acid. Polyols include alcohols having two or more hydroxy groups to include for example ethylene glycol, 1,3-propanediol, and 1,4-butanediol. Generally an ester monomer formed from a polycarboxylic acid and a polyol is reacted in a polycondensation to form a high molecular weight polyester. In an embodiment the polyester includes an aromatic polycarboxylic acid based polyester. The hydroxy-containing carboxylic acid includes for example lactic acid where its cyclic lactide monomer derivative can undergo a polycondensation using a metal cation catalyst to form a polylactic acid also known as a polylactide. Useful polyesters include for example poly(ethylene 2,6-naphthalenedicarboxylate) resins, terephthalic acid based polyesters including poly(1,3-propylene terephthalate) resins, poly(1,4-butylene terephthalate) resins and the poly(ethylene terephthalate) resin Eastapak® 9921 PET, from Eastman Chemical Company of Kingsport, Tenn., which has a density of 1.32 g/cm³ and a melting point of 243° C., and the polylactic acid PLA Polymer 4042D, from NatureWorks® LLC of Minnetonka, Minn., which has a density of 1.24 g/cm³ and a melt temperature of 202 to 218° C.

The halogen-containing polymer of the first film layer includes polyvinyl or vinylidene halide)s such as for example polyvinyl chloride)s and poly(vinylidene fluoride)s. Useful halogen-containing polymers include for example the polyvinyl chloride) resin Geon™ Vinyl Rigid Extrusion L0259, from PolyOne Corporation of Cleveland, Ohio, which has a specific gravity of 1.34 and melt temperature of 188° C.

The polycarbonate of the first film layer includes polymers that have repeating hydrocarbon based groups linked together by carbonate groups which are also known as carbonyldioxy groups. In an embodiment the polycarbonate has a density of 1.1 to 1.32 g/cm³ and a melt flow rate (ASTM D1238) at 300° C./1.2 kg of 0.5 to 40 g/10 minutes. In embodiments the polycarbonate includes an aromatic polycarbonate, a nonaromatic polycarbonate, or a mixture of two or more of any of the foregoing polycarbonates. The nonaromatic polycarbonates include polymers which can be prepared by metal catalyzed reaction of an epoxide with carbon dioxide. The aromatic polycarbonates include polymers which can be prepared by reaction of a polyhydroxy-substituted arene, to include for example bisphenol A also known as 4,4′-isopropylidenediphenol, with phosgene or a dialkyl or diaryl carbonate to include for example dimethyl carbonate. Arenes are aromatic unsaturated cyclic hydrocarbons. Useful polycarbonates include for example the polycarbonate Makrolon® 1804, from Bayer Material Science of Baytown, Tex., which has a density of 1.2 g/cm³ and a melt flow rate (ASTM D1238) at 300° C./1.2 kg of 6.5 g/10 minutes, and the polycarbonate Lupilon® 53000R, from Mitsubishi Chemical and available through Polymer Technology & Services, LLC of Murfreesboro, Tenn., which has a density of 1.2 g/cm³ and a melt flow rate (ASTM D1238) at 300° C./1.2 kg of 16.5 g/10 minutes and is made from bisphenol A.

The polyacrylonitrile of the first film layer includes a polyacrylonitrile homopolymer, a polyacrylonitrile copolymer, or a mixture of two or more of any of the foregoing polymers. The polyacrylonitrile copolymer includes polymers prepared from acrylonitrile and one or more comonomers where the comonomers include an olefin, a halogen-substituted olefin, an aryl-substituted olefin, or a mixture of two or more of any of the foregoing comonomers. Useful polyacrylonitriles include acrylonitrile-butadiene copolymer resins, acrylonitrile-styrene copolymer resins, and acrylonitrile-butadiene-styrene copolymer resins such as for example the acrylonitrile-butadiene-styrene or ABS copolymer resin TRILAC™ ABS-EXIOOO, from Polymer Technology & Services, LLC of Murfreesboro, Tenn., which is a high impact extrusion grade resin having a melt flow rate (ASTM D1238) at 220° C./10 kg of 7 g/10 minutes.

The aromatic polyether of the first film layer includes high molecular weight thermoplastic polymer resins having aromatic groups where the aromatic groups are linked together by oxygen atoms in two or more ether linkages. In embodiments the aromatic polyether has a number average molecular weight ranging from 1,000 to 1,000,000, from 2,000 to 500,000, from 3,000 to 250,000, or from 4,000 to 200,000. In embodiments the aromatic polyether includes one or more additional linkages selected from the group consisting of a sulfone linkage, a ketone linkage, an imide linkage, an amide linkage, a carboxylate ester linkage, a carbonate linkage, a sulfide linkage, an amine linkage, a carbamate ester linkage, and a mixture of two or more of any of the foregoing linkages. In other embodiments the aromatic polyether includes an aromatic polyether selected from the group consisting of an aromatic polyether ketone, an aromatic polyetheretherketone, an aromatic polyether imide, an aromatic polysulfone, an aromatic polyethersulfone, a polyphenylsulfone, and a mixture of two or more of any of the foregoing aromatic polyethers. Aromatic polyether ketones include polymers prepared from a condensation of a di(haloaryl) ketone, for example 4,4′-difluorobenzophenone, and a di(hydroxyaryl) ketone, for example 4,4′-dihydroxybenzophenone, in the presence of a base, for example potassium carbonate. Aromatic polyetheretherketones include polymers prepared from a condensation of a polyhydroxy-substituted arene, for example hydroquinone, and a di(haloaryl) ketone, for example 4,4′-difluorobenzophenone, in the presence of a base. Aromatic polyether imides include polymers prepared from a condensation of a bisimide, for example the bisimide formed from reacting 2 moles of 4-nitrilophthalic anhydride and 1 mole of 1,3-phenylenediamine, and a polyhydroxy-substituted arene, for example bisphenol A, in the presence of a base. Aromatic polysulfones include polymers prepared from a condensation of a di(haloaryl) sulfone, for example 4,4′-dichlorodiphenyl sulfone, and a polyhydroxy-substituted arene, for example bisphenol A, in the presence of a base. Aromatic polyethersulfones include polymers prepared from a condensation of a di(haloaryl) sulfone, for example 4,4′-dichlorodiphenyl sulfone, and a di(hydroxyaryl) sulfone, for example 4,4′-dihydroxydiphenyl sulfone, in the presence of a base. Polyphenyl sulfones include polymers prepared from a condensation of a di(haloaryl) sulfone, for example 4,4′-dichlorodiphenyl sulfone, and a polyhydroxy-substituted arene having two or more phenyl rings, for example 4,4′-biphenol, in the presence of a base. Useful aromatic polyethers include for example aromatic polyetheretherketone resins from Zeus Industrial Products of Orangeburg, S.C., aromatic polyether imide Ultem® resins from Sabic Innovative Plastics of Pittsfield, Mass., and aromatic polysulfone and aromatic polyethersulfone and polyphenylsulfone Ultrason® resins from BASF Corporation of Wyandotte, Mich.

The aromatic polyimide of the first film layer includes high molecular weight thermoplastic polymer resins having aromatic groups where the aromatic groups are linked together in two or more imide linkages. In embodiments the aromatic polyimide has a number average molecular weight ranging from 1,000 to 1,000,000, from 2,000 to 500,000, from 3,000 to 250,000, or from 4,000 to 200,000. In an embodiment the aromatic polyimide includes one or more additional linkages selected from the group consisting of a sulfone linkage, a ketone linkage, a carboxylate ester linkage, a carbonate linkage, a sulfide linkage, an amine linkage, a carbamate ester linkage, and a mixture of two or more of any of the foregoing linkages. Aromatic polyimides include polymers prepared from a condensation of an aromatic tetracarboxylic anhydride, for example pyromellitic dianhydride, and an aromatic diamine, for example 1,4-phenylenediamine. Useful aromatic polyimides include for example the aromatic polyimide EXTEM® resins from Sabic Innovative Plastics.

The aromatic polyamide-imide of the first film layer includes high molecular weight thermoplastic polymer resins having aromatic groups where the aromatic groups are linked together in two or more linkages where the linkages include at least one amide linkage and at least one imide linkage. In embodiments the aromatic polyamide-polyimide has a number average molecular weight ranging from 1,000 to 1,000,000, from 2,000 to 500,000, from 3,000 to 250,000, or from 4,000 to 200,000. In an embodiment the aromatic polyamide-polyimide includes one or more additional linkages selected from the group consisting of a sulfone linkage, a ketone linkage, a carboxylate ester linkage, a carbonate linkage, a sulfide linkage, an amine linkage, a carbamate ester linkage, and a mixture of two or more of any of the foregoing linkages. Aromatic polyamide-imides include polymers prepared from a condensation of an aromatic dicarboxylic anhydride carboxylic acid halide, for example trimellitic anhydride acid chloride, and an aromatic diamine, for example 4,4′-methylenedianiline. Useful aromatic polyamide-imides include for example the aromatic polyamide-imide Torlon® resins from Solvay Advanced Polymers, LLC of Alpharetta, Ga.

The film or a film layer or film layers of the film, to include the first film layer, can contain one or more additives to improve processing during film manufacture and during conversion to a label and to improve label end use performance. The additives include a nucleating agent, an antiblocking agent, a processing aid, a slip agent, an antistatic agent, a pigment, a cavitating agent, an inorganic filler, a heat stabilizer, an antioxidant, a flame retardant, an acid acceptor, a visible and/or ultraviolet light stabilizer, or a mixture of two or more of any of the foregoing additives. The additives can be present in the above described thermoplastic polymers as supplied by a vendor or can be introduced into the film or a film layer as an additive concentrate where the additive is present generally in a relatively large amount of 2 to 90% by weight, depending on its use, in the concentrate with a thermoplastic polymer carrier. The additives, depending on their use, can be present in the film or a film layer from 0.001% to 90% by weight. Additives for use in the film or a film layer are further described in U.S. Pat. No. 6,821,592 to Rodick and U.S. Pat. No. 7,217,463 to Henderson.

In an embodiment the first film layer is monolayered and has only one layer. In another embodiment the first film layer is multilayered and has two or more layers. In embodiments the one layer of the monolayered first film layer or each of the two or more layers of the multilayered first film layer has a tensile modulus (ASTM D882) in a machine direction and/or a transverse direction of at least 900 MPa, at least 1030 MPa, at least 1160 MPa, or at least 1260 MPa after immersion in water at a temperature of about 80° C. for at least about 3 minutes and has an absolute areal dimensional change (ASTM D1204) of less than 5.0%, less than 4.9%, less than 4.2%, or less than 3.5% after immersion in water at a temperature of about 80° C. for at least about 3 minutes. In embodiments the thickness of the one layer of the monolayered first film layer or the thickness of the two or more layers of the multilayered first film layer in combination is greater than the thickness of the adhesive layer, or the thickness of the one layer of the monolayered first film layer or the thickness of the two or more layers of the multilayered first film layer in combination is at least 5%, at least 10%, at least 20%, at least 30%, at least 40%, at least 50%, or at least 60% greater than the thickness of the adhesive layer. In other embodiments the one layer of the monolayered first film layer or each of the two or more layers of the multilayered first film layer has a water absorption (ASTM D570) on a weight basis of less than 2.1%, less than 1.6%, or less than 1.2% after immersion in water at a temperature of about 80° C. for at least about 2 hours. In other embodiments the one layer of the monolayered first film layer or each of the two or more layers of the multilayered first film layer has a water absorption (ASTM D570) on a weight basis of 0.1 to 2%, 0.15 to 1.8%, or 0.2 to 1.6% after immersion in water at a temperature of about 80° C. for at least about 2 hours. In an embodiment the first film layer, as described hereinabove, can contain one or more other thermoplastic polymers provided that the first film layer maintains its tensile modulus and dimensional change and water absorption properties as described hereinabove.

Referring to FIGS. 19B, 19C, 19D and 19E the labels 220, 230, 240 and 250 of the present disclosure comprise a film that comprises a second film layer 222. The second film layer compared to the first film layer, after immersion in water at a temperature of about 80° C., has a lower tensile modulus in a machine direction and/or a transverse direction or a greater two-dimensional change in area as measured in a machine direction and a transverse direction or a combination of the lower tensile modulus and the greater two-dimensional change in area. In embodiments the second film layer has a property selected from the group consisting of a tensile modulus (ASTM D882) in a machine direction and a transverse direction below 900 MPa or below 1030 MPa or below 1160 MPa or below 1260 MPa after immersion in water at a temperature of about 80° C. for at least about 3 minutes, an absolute areal dimensional change (ASTM D1204) of at least 4.9% or at least 4.2% or at least 3.5% after immersion in water at a temperature of about 80° C. for at least about 3 minutes, and a combination of the two foregoing properties. In other embodiments the second film layer has a water absorption (ASTM D570) on a weight basis of less than 0.1%, less than 0.15%, or less than 0.2% or in the alternative of more than 2.1%, more than 2%, more than 1.8%, or more than 1.6% after immersion in water at a temperature of about 80° C. for at least about 2 hours.

The second film layer comprises at least one thermoplastic polymer. In embodiments the at least one thermoplastic polymer of the second first film layer comprises a polymer selected from the group consisting of a polyolefin where the polyolefin includes homopolymers and copolymers of olefins having 2 to 12 carbon atoms, a (meth)acrylate polymer to include for example poly(alkyl acrylate)s, a styrene polymer, a polyester, a halogen-containing polymer, a polyacrylonitrile, a polyamide, a polyvinyl alcohol), an olefin-vinyl carboxylate copolymer to include for example ethylene-vinyl acetate copolymers, an olefin-vinyl alcohol copolymer, a polyurethane, a cellulosic based polymer, an olefin-(meth)acrylic acid copolymer to include for example ethylene-methacrylic acid copolymers, a cyclic olefin homopolymer, a cyclic olefin copolymer, a metal salt of an olefin-(meth)acrylic acid copolymer to include for example zinc or sodium salts of ethylene-methacrylic acid copolymers, and a mixture of two or more of any of the foregoing polymers. In other embodiments the at least one thermoplastic polymer of the second first film layer comprises a polyethylene, a polyamide, an olefin-vinyl alcohol copolymer, a cyclic olefin copolymer, and a mixture of two or more of any of the foregoing polymers.

The polyethylene of the second film layer includes polymers selected from the group consisting of a polyethylene homopolymer, a polyethylene copolymer, and a mixture of two or more of any of the foregoing polymers. The polyethylene of the second film layer has a density of 0.86 to 0.98 and a melt index (ASTM D1238) at 190° C./2.16 kg of 0.5 to 40 g/10 minutes. The polyethylene copolymers include polymers prepared from ethylene and an olefin comonomer having 3 to 12 carbon atoms where the comonomer content on a weight basis is 0.1 to 45%. Useful polyethylenes include for example the high density polyethylene resin Alathon® M6030, from Equistar Chemicals, LP of Houston, Tex., which has a density of 0.96 g/cm³ and a melt index (ASTM D1238) at 190° C./2.16 kg of 3 g/10 minutes.

The polyamide of the second film layer includes polymers selected from the group consisting of a nonaromatic polyamide, an aromatic polyamide, and mixtures of two or more of any of the foregoing polymers. Nonaromatic polyamides do not contain repeating aromatic groups while aromatic polyamides contain only repeating aromatic groups or contain both repeating aromatic groups and repeating nonaromatic groups. Polyamides can be prepared by a condensation of an amino carboxylic acid or an amino carboxylic acid halide monomer, by a ring opening polymerization of a lactam to include for example a ring opening polymerization of caprolactam to form polycaprolactam or nylon 6, or by a condensation of a polyamine monomer and a polycarboxylic acid or polycarboxylic acid halide monomer to include for example the condensation of 1,6-hexanediamine and adipic acid or adipic acid chloride to form the polyamide nylon 66. Useful polyamides include for example the nonaromatic nylon 6 and nylon 66 Ultramid® resins from BASF Corporation of Florham Park, N.J. and the aromatic nylon MXD6 resins from Mitsubishi Gas Chemical American, Inc. of New York, N.Y. where the nylon MXD6 resins are derived from meta-xylylenediamine and adipic acid or an adipic acid halide.

The olefin-vinyl alcohol copolymer of the second film layer includes at least one copolymer of an olefin monomer containing 2 to 12 carbon atoms and a vinyl alcohol monomer where the vinyl alcohol monomer is usually derived from vinyl acetate and the olefin content of the olefin-vinyl alcohol copolymer ranges on a mole basis from 5% to 80%, 12% to 68%, or 20% to 55%. Useful olefin-vinyl alcohol copolymers include for example the ethylene-vinyl alcohol copolymer EVAL® resins from EVAL Americas of Houston, Tex.

The cyclic olefin copolymer of the second film layer includes at least one copolymer of a cyclic olefin monomer and an olefin monomer that contains 2 to 12 carbon atoms where the cyclic olefin monomer content of the cyclic olefin copolymer on a weight basis ranges from 5% to 95%, 27% to 90%, or 50% to 90%. Useful cyclic olefin copolymers include for example the cyclic olefin copolymer TOPAS® resins from TOPAS Advanced Polymers, Inc. of Florence, Ky. where the TOPAS® resins are derived from norbornene and ethylene.

The second film layer can contain, as described hereinabove for the first film layer, one or more additives. In an embodiment the second film layer is monolayered and has only one layer. In another embodiment the second film layer is multilayered and has two or more layers. In embodiments the one layer of the monolayered second film layer or each of the two or more layers of the multilayered second film layer has a property selected from the group consisting of a tensile modulus (ASTM D882) in a machine direction and a transverse direction below 900 MPa or below 1030 MPa or below 1160 MPa or below 1260 MPa after immersion in water at a temperature of about 80° C. for at least about 3 minutes, an absolute areal dimensional change (ASTM D1204) of at least 5.0%, at least 4.9%, or at least 4.2% or at least 3.5% after immersion in water at a temperature of about 80° C. for at least about 3 minutes, and a combination of the two foregoing properties. In other embodiments the one layer of the monolayered second film layer or each of the two or more layers of the multilayered second film layer has a water absorption (ASTM D570) on a weight basis of less than 0.1%, less than 0.15%, or less than 0.2% or in the alternative of more than 2.1%, more than 2%, more than 1.8%, or more than 1.6% after immersion in water at a temperature of about 80° C. for at least about 2 hours. In an embodiment the second film layer, as described hereinabove, can contain one or more other thermoplastic polymers provided that the second film layer maintains its tensile modulus or dimensional change or water absorption properties or a combination of these properties as described hereinabove.

Referring to FIGS. 19A, 19B, 19C, 19D and 19E the labels 210, 220, 230, 240 and 250 of the present disclosure comprise an adhesive layer 214. The adhesive layer comprises an adhesive where the adhesive includes an adhesive selected from the group consisting of a natural adhesive, a synthetic adhesive, and a mixture of two or more of any of the foregoing adhesives. Synthetic adhesives include pressure sensitive adhesives. In an embodiment the adhesive of the adhesive layer is a pressure sensitive adhesive. A pressure sensitive adhesive is an adhesive that forms a bond between the adhesive and an adherend, to include for example where the adherend is a polymeric film or a container, with the application of pressure. Pressure sensitive adhesives (PSAs) include acrylic-based PSAs, rubber-based PSAs, and silicone-based PSAs. In an embodiment the adhesive of the adhesive layer is an acrylic-based pressure sensitive adhesive. Pressure sensitive adhesives include emulsion or water-based PSAs, solvent-based PSAs, and solid PSAs which are water-free and solvent-free to include for example hot melt pressure sensitive adhesives. In an embodiment the adhesive of the adhesive layer is an emulsion acrylic-based pressure sensitive adhesive. In several embodiments the adhesive of the adhesive layer, to include for example a pressure sensitive adhesive, has a property selected from the group consisting of a decrease in adhesion strength at elevated temperatures generally above a room or ambient temperature, a decrease in adhesion strength on contact with an aqueous caustic solution such as for example an aqueous caustic soda solution, and a combination of the two foregoing properties. In other embodiments the adhesive of the adhesive layer is used on a dry weight coating basis at 5 to 40 g/m² (grams per square meter), 8 to 35 g/m², or 10 to 30 g/m². Pressure sensitive adhesives are described in Encyclopedia of Polymer Science and Engineering, Vol. 13, Wiley-Interscience Publishers, New York, 1988 and in Polymer Science and Technology, Vol. 1, Interscience Publishers, New York, 1964. Useful adhesives are available from H. B. Fuller Company of Saint Paul, Minn. and Henkel Corporation of Gulph Mills, Pa.

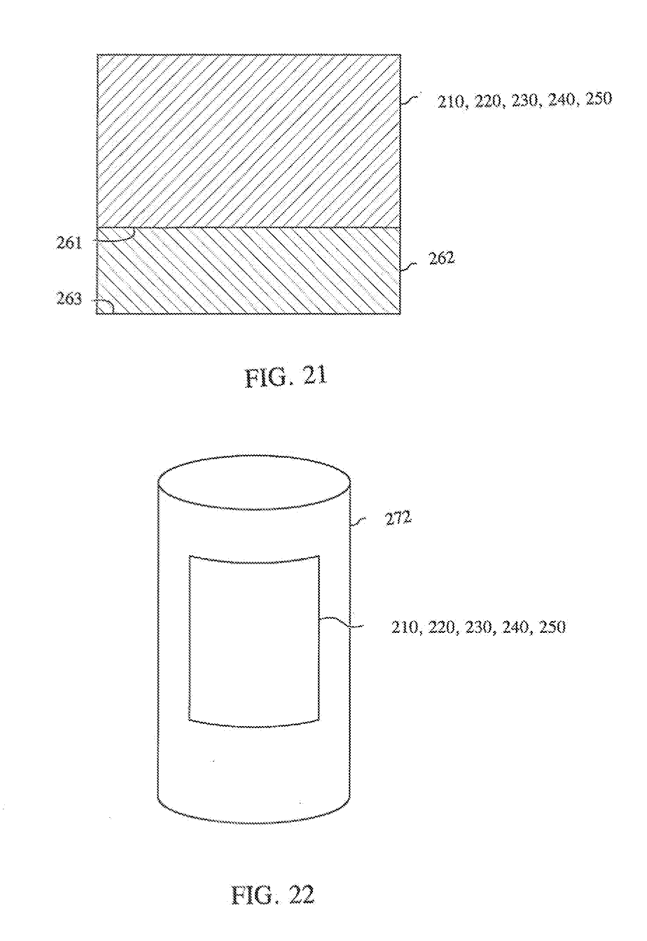

Referring to FIG. 21 the exemplary labels 210, 220, 230, 240 and 250 can include a release liner 262. The release liner can be monolayered having only one layer or can be multilayered having two or more layers. The layer or layers of the release liner can include a layer selected from the group consisting of a paper layer to include for example a calendered glassine paper layer, a polymeric layer to include for example a polyolefin-based layer or a poly(ethylene terephthalate)-based layer, and in the case of a multilayered release liner a combination of two or more of any of the foregoing layers. The release liner has a first surface 261 and a second surface 263 and normally includes a release coating on at least the first surface of the release liner. The release coating, to include for example an organosiloxane polymer release coating also known as a silicone release coating, allows the release liner to be releasably attached to the adhesive layer of the label so that the release liner can be removed from the adhesive layer of the label during a labeling process leaving the adhesive layer adhesively joined to the film of the label.

Multilayered films can include one or more tie layers and/or one or more lamination adhesive layers. Referring to FIGS. 19D and 19E the labels 240 and 250 can include at least one layer226 which can be a tie layer or a lamination adhesive layer. When present in the label a tie layer is located between two layers of the film and generally functions to improve adherence between the two layers of the film. Depending on the compositions of the two layers of the film which the tie layer is located between, the tie layer can include at least one thermoplastic polymer selected from the group consisting of a polyolefin to include for example ethylene and propylene homopolymers and copolymers, an unsaturated carboxylic acid or anhydride grafted polyolefin to include for example maleic anhydride grafted polypropylenes and maleic anhydride grafted polyethylenes, an alkene-unsaturated carboxylic acid or unsaturated carboxylate ester copolymer to include for example ethylene-alkyl methacrylate copolymers and ethylene-vinyl acetate copolymers, a metal salt of an alkene-unsaturated carboxylic acid copolymer to include for example ionomers which are sodium or zinc salts of ethylene-methacrylic acid copolymers, a styrene homopolymer or copolymer, a cyclic olefin homopolymer or copolymer, a halogen-containing polymer, a polyurethane, a polycarbonate, a polyacrylonitrile, a polyamide, an aromatic polyether, an aromatic polyimide, an aromatic polyamide-imide, a (meth)acrylate polymer, a polyester to include for example poly(ethylene terephthalate)s, a hydrocarbon resin to include for example hydrogenated polyterpene resins, and a mixture of two or more of any of the foregoing polymers.

The film of the exemplary label can include one or more coatings, also known as topcoats, on its first and second surfaces to enhance adhesion of a printing ink or an adhesive to the film or to provide protection including for example from abrasion and/or moisture. The coating can be an ink-receptive or adhesive-receptive material to include for example an acrylic primer or an abrasion or moisture resistant material to include for example a polyolefin or polyester where the coating can be applied in a liquid form and dried or allowed to dry.

These exemplary films and labels can be prepared by one or more steps that include steps selected from the group consisting of an extrusion of a single layer, a coextrusion of two or more layers, a lamination of two or more layers, an application of one or more coatings, and a combination of two or more of any of the foregoing steps. The extrusion or coextrusion steps can be done through linear dies or annular dies. In an embodiment the film is monolayered and contains a monolayered first film layer which is formed by an extrusion step. In embodiments the film is multilayered and contains a multilayered first film layer which is formed by a coextrusion step, by a combination of extrusion and lamination steps, or by a combination of extrusion and coextrusion and lamination steps. In other embodiments the film is multilayered and contains a first film layer and a second film layer where the first film layer can be monolayered or multilayered and the second film layer can be monolayered or multilayered. The second film layer can be formed separately from the first film layer or together with the first film layer by one or more steps as described above for the film, label, and the monolayered and multilayered first film layer. In an embodiment a multilayered film contains a two-layered first film layer where each of the two layers is formed by an extrusion step and then the first film layer is formed by a lamination step. The lamination can be done by bringing layers together usually under pressure with or without heat and with or without a lamination adhesive. Lamination adhesives include for example polyurethane based adhesives and acrylic based adhesives such as acrylic based permanent pressure sensitive adhesives. In an embodiment the lamination is done by bringing layers together at a pressure of 69 to 690 KPa (kilopascals) at an ambient temperature of 23° C. with a lamination adhesive, a polyurethane based adhesive, between the layers. In an embodiment a multilayered film contains a monolayered first film layer and a monolayered second film layer where each layer is formed by an extrusion step and then the multilayered film is formed by a lamination step. In an embodiment a multilayered film contains a multilayered first film layer that contains six layers where five of the layers are formed by a coextrusion step, the sixth layer is formed by an extrusion step, and the multilayered film is formed by lamination of the coextruded layers with the extruded layer.

In one embodiment, the film is nonoriented or not stretched. In other embodiments, the film is oriented or stretched uniaxially in one direction, which can be the machine direction or the transverse direction, or the film is oriented biaxially in two directions which are usually the machine direction and the transverse direction. Orienting or stretching is stretching the film or layers of the film to align the polymer chains of the thermoplastic polymer or polymers, present in the film or layers of the film, in the direction of the stretching. The stretching results in the film or layers of the film having an increase in length and consequently a decrease in thickness. Although the stretching can be done at any temperature, it is usually done at an elevated temperature near the softening temperature of the polymer or polymers. The stretching generally increases the stiffness or tensile modulus (ASTM D882) of the film or layers of the film in the direction of the stretching. In embodiments the film or layers of the film can be oriented by stretching them uniaxially or biaxially in a stretch ratio range of 2 to 12, 3 to 10, or 4 to 8 where the stretch ratio is the ratio of the film length after stretching to the film length before stretching.

In order to provide dimensional stability to an oriented film or layers of the film so they do not shrink or distort appreciably especially when exposed to elevated temperatures, the oriented film or layers of the film are annealed or heat set by heating the tensioned film or layers of the film near the softening temperature of the constituent polymer or polymers. In embodiments the annealed film or layers of the film have a linear shrinkage (ASTM D1204) at 100° C. in the machine direction and the transverse direction of less than 5%, less than 4.9%, less than 4.8%, or less than 3%. In an embodiment the film is a monolayered film and has only one layer. In an embodiment the film is a multilayered film and has two or more layers. In embodiments the first film layer is monolayered where the first film layer is nonoriented or is oriented and annealed. In embodiments the multilayered film contains a multilayered first film layer where the multilayered first film layer has two or more layers where all the layers of the first film layer are nonoriented, all the layers of the first film layer are oriented and annealed, or part of the layers of the first film layer are oriented and annealed where part of the layers of the first film layer includes at least one layer of the first film layer but not all the layers of the first film layer. In embodiments the multilayered film has a first film layer and a second film layer where both the first film layer and second film layer are monolayered, both the first film layer and second film layer are multilayered, the first film layer is monolayered and the second film layer is multilayered, or the first film layer is multilayered and the second film layer is monolayered. The monolayered or multilayered second film layer can be nonoriented or oriented and annealed as described above for the monolayered and multilayered first film layer.

In an embodiment, referring to FIGS. 19A, 19B, 19C, 19D and 19E the label has a thickness T which includes the thickness of the first film layer T_{FFL} and the thickness of the adhesive layer T_{AL}, or the thickness of the first film layer T_{FFL}, the thickness of the second film layer T_{SFL} and the thickness of the adhesive layer T_{AL}, or the thickness of the first film layer T_{FFL}, the thickness of the second film layer T_{SFL}, the thickness of the tie layer T_{TL} or the lamination adhesive layer T_{LAL} and the thickness of the adhesive layer T_{AL}. The film has a thickness which is the thickness of the first film layer T_{FFL}, or includes the thickness of the first film layer T_{FFL} and the thickness of the second film layer T_{SFL}, or includes the thickness of the first film layer T_{FFL}, the thickness of the second film layer T_{SFL} and the thickness of the tie layer T_{TL} or the lamination adhesive layer T_{LAL}. In embodiments the thickness in micrometers of the film and the first film layer T_{FFL} can range from 5 to 254, 6 to 127, or 7 to 63.5. In embodiments the first film layer, the second film layer, the tie layer and the lamination adhesive layer can each have a thickness, respectively T_{FFL} and T_{SFL} and T_{TL} and T_{LAL}, in micrometers ranging from 1.7 to 85, 2 to 42, or 2.3 to 21.

The film can be treated on one surface or both of its surfaces to enhance performance to include abrasion resistance, moisture resistance, and adhesion of an ink or adhesive to a surface or surfaces of the film. Surface treatments include a corona discharge treatment, a flame treatment, a plasma treatment, a topcoat treatment, or combinations of two or more of any of the foregoing treatments. Topcoat treatments include treatment of one or both surfaces of the film with an ink-receptive or adhesive-receptive material such as for example an acrylic primer and/or with a protective varnish. The treatments can be done any time during the manufacture and subsequent processing of the film and label where the time of the treatment generally depends on the performance enhancement. For example, a treatment to enhance ink reception would precede a printing step while a topcoating for abrasion resistance might follow a printing step. In an embodiment the first surface or the second surface of the film is surface treated to enhance adhesion of an ink to the film. In an embodiment, the second surface of the film is surface treated to enhance adhesion of an adhesive to the film. In an embodiment, the first surface of the film is surface treated to enhance abrasion resistance and/or moisture resistance of the film.

In several embodiments the label includes a film, an adhesive layer, and a release liner. The label of the present disclosure can be prepared in any manner. In an embodiment a film or one or more film layers can be slit into widths suitable for subsequent processing steps or labeling operations. In embodiments the film can be coated with an adhesive to form an adhesive layer and then the film and adhesive layer can be combined in a lamination step with a release liner, or a release liner can be coated with an adhesive to form an adhesive layer and then the release liner and adhesive layer can be combined in a lamination step with the film. The label containing a film, adhesive layer and release liner can be further processed to include printing steps and/or die-cutting steps. In an embodiment the label, containing a film and adhesive layer and release liner, can be printed using any printing means and using any printing ink. Printing means include for example offset lithography, flexographic, digital, thermal, inkjet and laser. Printing inks include for example water-based inks, solvent-based inks and UV-activated inks. Alternatively in another embodiment a film or a film layer can be printed prior to eventually combining with an adhesive layer or with an adhesive layer and release liner as described above. In embodiments the film is monolayered or multilayered and has a first outer surface and a second outer surface where the first outer surface of the film has a print layer or the second outer surface of the film has a print layer which can also have an adhesive layer adhesively joined to the print layer. In an embodiment the film is multilayered and has two or more layers where a print layer is located between the layers of the film. In an embodiment the film is multilayered and has a first film layer and a second film layer where either the first film layer or the second film layer is printed and then the first film layer and the second film layer are combined in a lamination step where a print layer is located between the first film layer and second film layer. In an embodiment a label containing a printed or nonprinted film, adhesive layer and release liner is die-cut using any die-cutting means, to include for example a rotary cutting die, where as a result of the die-cutting a die-cut ladder-shaped matrix of the film and adhesive layer is formed that contains a series of individual labels on the release liner which acts as a carrier for the labels. This die-cut series of labels can then be used to label articles in a labeling process where individual labels are successively removed from the release liner and the die-cut ladder-shaped matrix. Processing to include extrusion, coextrusion, orienting, annealing, coating, surface treatments, label construction, printing, die-cutting and labeling of articles is further described in U.S. Pat. No. 7,217,463 to Henderson and U.S. Pat. No. 7,144,542 to Holzer et al.

In an embodiment a label includes a film having an upper or first surface and a lower or second surface and comprising a first film layer, and an adhesive layer having an upper or first surface and a lower or second surface where the first surface of the adhesive layer is adhesively joined to the second surface of the film. In an embodiment a label 210 includes a film comprising a first film layer 212 having a first surface 211 and a second surface 13 and a thickness T_{FFL}, and an adhesive layer 214 having a first surface 215 and a second surface 17 and a thickness T_{AL} where the first surface 215 of the adhesive layer 214 underlies the second surface 213 of the first film layer 212. The term “underlie” and related term “overlie” when referring to a first layer underlying or overlying a second layer mean that the first layer can partially or fully cover the second layer and that the first layer and second layer can be in direct contact with each other or that one or more intermediate layers, to include for example tie layers or lamination adhesive layers, can be located between the first layer and second layer. In an embodiment a label 220 includes a film comprising a second film layer 222 having a first surface 221 and a second surface 223 and a first film layer 212 having a first surface 211 and a second surface 213 and a thickness T_{FFL}, and an adhesive layer 214 having a first surface 215 and a second surface 217 and a thickness T_{AL} where the first surface 211 of the first film layer 212 underlies the second surface 223 of the second film layer 222 and the first surface 215 of the adhesive layer 214 underlies the second surface 213 of the first film layer 212. In an embodiment a label 230 includes a film comprising a first film layer 212 having a first surface 211 and a second surface 213 and a thickness T_{FFL} and a second film layer 222 having a first surface 221 and a second surface 223, and an adhesive layer 214 having a first surface 215 and a second surface 217 and a thickness T_{AL} where the first surface 221 of the second film layer 222 underlies the second surface 13 of the first film layer 212 and the first surface 215 of the adhesive layer 214 underlies the second surface 223 of the second film layer 222. In an embodiment a label 240 includes a film comprising a second film layer 222 having a first surface 221 and a second surface 223 and a thickness T_{SFL} and a tie layer or lamination adhesive layer 226 having a first surface 225 and a second surface 227 and a first film layer 212 having a first surface 211 and a second surface 213, and an adhesive layer 214 having a first surface 215 and a second surface 217 and a thickness T_{AL} where the first surface 225 of the tie or lamination adhesive layer 226 underlies the second surface 223 of the second film layer 222 and the first surface 211 of the first film layer 212 underlies the second surface 227 of the tie or lamination adhesive layer 226 and the first surface 215 of the adhesive layer 214 underlies the second surface 213 of the first film layer 212. In an embodiment a label 250 includes a film comprising a first film layer 212 having a first surface 211 and a second surface 213 and a tie layer or lamination adhesive layer 226 having a first surface 225 and a second surface 227 and a second film layer 222 having a first surface 221 and a second surface 223 and a thickness T_{SFL}, and an adhesive layer 214 having a first surface 215 and a second surface 217 and a thickness T_{AL} where the first surface 225 of the tie or lamination adhesive layer 226 underlies the second surface 213 of the first film layer 212 and the first surface 221 of the second film layer 222 underlies the second surface 227 of the tie or lamination adhesive layer 226 and the first surface 215 of the adhesive layer 214 underlies the second surface 223 of the second film layer 222. In embodiments as described hereinabove the thickness T_{FFL} of the first film layer 212 is greater than the thickness T_{AL} of the adhesive layer 214. In embodiments the film or label has high clarity visual aesthetics where the film or label is clear having a TAPPI (Technical Association of the Pulp and Paper Industry) T425 opacity of 12% or less, 10% or less, or 8% or less and a haze (ASTM D2003) of 12% or less, 10% or less, or 8% or less. In embodiments the film or label is dispensable during a labeling operation where the film or label has an ISO (International Organization for Standardization) 2493 bending resistance in mN (milliNewtons) of at least 14, at least 16, at least 18, or at least 20. In embodiments a label 210, 220, 230, 240 or 250 includes an adhesive layer 214 having a second surface 217 and a release liner 262 having a first surface 261 and a second surface 263 where the first surface 261 of the release liner 262, which normally includes a release coating, is releasably attached to the second surface 217 of the adhesive layer 214. The label of the present disclosure can comprise a monolayered or multilayered first film layer and a monolayered or multilayered second film layer where the label can include any type of layer construction regarding the ordering of film layers such as for example alternating first film layers and second film layers.

### High Modulus Film and Label Examples

The following nonlimiting film examples and label examples further describe and illustrate the present disclosure.

The following Table lists film examples that were used in subsequent label examples and also provides the source and physical properties of the films.

| Film | | Tensile | | Water |
|---|---|---|---|---|
| Example | Resin | Modulus, | Areal Dimensional | Absorption, |
| No. | Identity¹ | MPa² | Change, %³ | Wt. %⁴ |
| 1 | PC | 1810 | 0.4 | 0.9 |
| 2 | BOPP | 1450 | None | 0.4 |
| 3 | BOPET | 3800 | 0.1 | 0.5 |
| 4 | PMMA | 1290 | 1.4 | — |
| 5 | PA | 600 | 5.4 | 2.6 |

¹Film Example No. 1 was a 25.4 micrometer thick polycarbonate (PC) monolayered film prepared by extrusion without orientation using Mitsubishi bisphenol A based PC resin E2000. Film Example No. 2 was a 50 micrometer thick biaxially oriented polypropylene (BOPP) monolayered film 50LL534 obtained from ExxonMobil of Baytown, TX. Film Example No. 3 was a 19 micrometer thick biaxially oriented poly(ethylene terephthalate) (BOPET) monolayered film 2CSRN19 obtained from Mitsubishi. Film Example No. 4 was a 50.8 micrometer thick poly(methyl methacrylate) (PMMA) monolayered film prepared by extrusion without orientation using PSR-9 impact modifier containing PMMA resin manufactured by Arkema Inc. Film Example No. 5 was a 58.4 micrometer thick polyamide (PA) monolayered film prepared by extrusion without orientation using Mitsubishi meta-xylylenediamine based MXD6 resin.
²Tensile modulus (ASTM D882) was measured in the machine direction after immersion of the film in water at a temperature of about 80° C. for at least about 3 minutes.
³Absolute areal dimensional change (ASTM D1204) in the machine and transverse directions was measured after immersion of the film in water at a temperature of about 80° C. for at least about 3 minutes. There was no measurable dimensional change for Film Example No. 2.
⁴Water absorption (ASTM D570) was measured after immersion of the film in water at a temperature of about 80° C. for at least about 2 hours.

The foregoing types of labels are exemplary in nature, and any suitable type of label may be removed using processes of the present disclosure. In some embodiments, labels may be used that will withstand removal during normal temperature and moisture exposure during use, transport, and storage conditions.

### Exemplary Label Removal Processes

The following label removal processes are illustrative of embodiments of the present disclosure.

### Label Removal Examples 1-4

Pressure sensitive adhesive composition described in Example 16 above was coated on a siliconized polyester liner at a coat weight of 20 gsm and then transferred onto a curling film. Labels are adhered to the glass bottles with diameter 68 mm.

### Example 1

Pressure sensitive adhesive composition described in Example 16 above was coated on a siliconized polyester liner at a coat weight of 20 gsm and then transferred onto a curling film. Labels were adhered to the glass bottles with diameter 68 mm. The label removal test consisted of application of steam of about 100° C. to the label. The label was removed in about 30-40 seconds time. The curvature of the label, when heated, was opposite to the curve of the bottle.

### Example 2

Pressure sensitive adhesive composition described in Example 16 above may be coated on a siliconized polyester liner at a coat weight of 20 gsm and then may be transferred onto a curling film. Labels may then be adhered to the glass bottles with diameter 68 mm. The label removal test may be conducted by application of hot water jet at about 80° C. to the label. The label is expected to be removed in about 10-20 seconds time, partially in light of the jet force expected to be present from application of the water. The curvature of the label, when heated, is expected to be opposite to the curve of the bottle.

### Example 3

Pressure sensitive adhesive composition described in Example 16 above was coated on a siliconized polyester liner at a coat weight of 20 gsm and then transferred onto a curling film. Labels were adhered to the glass bottles with diameter 68 mm. The label removal test consisted of immersing the labeled glass bottle in a hot water bath at about 80° C. The label was removed in about 20-30 seconds. The curvature of the label, when heated, was opposite to the curve of the bottle.

### Example 4

Pressure sensitive adhesive composition described in Example 16 above may be coated on a siliconized polyester liner at a coat weight of 20 gsm and then may be transferred onto a curling film. Labels may then be adhered to the glass bottles with diameter 68 mm. The label removal test may include applying hot air at about 100° C. to the label. The label is expected to be fully or partially removed in about 60-120 seconds. The curvature of the label, when heated, is expected to be opposite to the curve of the bottle.

### Label Removal Examples 5-8

### Example 5

Pressure sensitive adhesive composition described in Example 16 above may be coated on a siliconized polyester liner at a coat weight of 20 gsm and then may be transferred onto a shrink film made of 45 micron PETG. Labels may then be adhered to the glass bottles with diameter 68 mm without using heat. The label removal test may include applying steam at about 100° C. to the label. The label is expected to be removed in about 30-40 seconds.

### Example 6

Pressure sensitive adhesive composition described in Example 16 above may be coated on a siliconized polyester liner at a coat weight of 20 gsm and then may be transferred onto a shrink film made of 45 micron PETG. Labels may then be adhered to the glass bottles with diameter 68 mm. The label removal test may include applying a hot water jet at 80° C. to the label. The label is expected to be removed in about 10-20 seconds, partially as a result of the jet force.

### Example 7

Pressure sensitive adhesive composition described in Example 16 above was coated on a siliconized polyester liner at a coat weight of 20 gsm and was then transferred onto a shrink film made of 45 micron PETG. Labels were then adhered to the glass bottles with diameter 68 mm without using heat. The label removal test included immersing the labeled glass bottle in hot water bath at about 80° C. The label was removed in about 20-30 seconds.

### Example 8

Pressure sensitive adhesive composition described in Example 16 above may be coated on a siliconized polyester liner at a coat weight of 20 gsm and then may be transferred onto a shrink film made of 45 micron PETG. Labels may then be adhered to the glass bottles with diameter 68 mm without using heat. The label removal test may include applying hot air at about 100° C. to the label. The label is expected to be removed in about 60-120 seconds.

### Label Removal Examples 9-12

### Example 9

Pressure sensitive adhesive composition of Comparative Example A described above was coated on a siliconized polyester liner at a coat weight of 20 gsm and was then transferred onto a shrink film made of 45 micron PETG. Labels were then adhered to the glass bottles with diameter 68 mm without using heat. The label removal test included applying steam of about 100° C. to the label. The label was removed in about 50-80 seconds.

### Example 10

Pressure sensitive adhesive composition of Comparative Example A described above may be coated on a siliconized polyester liner at a coat weight of 20 gsm and then may be transferred onto a shrink film made of 45 micron PETG. Labels may then be adhered to the glass bottles with diameter 68 mm without using heat. The label removal test may include applying a hot water jet at about 80° C. to the label. The label is expected to be removed in about 30-40 seconds time.

### Example 11

Pressure sensitive adhesive composition of Comparative Example A described above was coated on a siliconized polyester liner at a coat weight of 20 gsm and was then transferred onto a shrink film made of 45 micron PETG. Labels were then adhered to the glass bottles with diameter 68 mm without using heat. The label removal test included immersing the labeled glass bottle in a hot water bath at about 80° C. The label was removed in about 40-60 seconds.

### Example 12

Pressure sensitive adhesive composition of Comparative Example A described above may be coated on a siliconized polyester liner at a coat weight of 20 gsm and then may be transferred onto a shrink film made of 45 micron PETG. Labels may then be adhered to the glass bottles with diameter 68 mm without using heat. The label removal test may include applying hot air at about 100° C. to the label. The label is expected to be removed in about 60-120 seconds.

As indicated above, the processes described herein may be used and modified in any suitable manner. In some embodiments, the processes of the present disclosure for removing labels may have particular utility in the food and beverage container industry, and particularly for bottles, including glass and plastic bottles, used in the beverage industry. In some instances, the present disclosure may be used in a process to recycle glass bottles or to prepare glass bottles for reuse. In other embodiments, other containers or other materials may be recycled or prepared for reuse using the processes contemplated and disclosed herein.

These and other modifications and variations to the present disclosure may be practiced by those of ordinary skill in the art without departing from the spirit and scope of the present disclosure, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the disclosure as further described in such appended claims. Therefore, the spirit and scope of the appended claims should not be limited to the exemplary description of the versions contained herein.

What is claimed is:

1. A method for removing a label affixed to a material, the method comprising:
exposing the label to one or more of heat, hot gas, or hot liquid having a predetermined temperature,
wherein the exposure continues for a period sufficient for the label to release from the material,
and wherein the exposure is in the absence of any caustic solution.

2. The method of claim 1 wherein the material is a container.

3. The method of claim 2 wherein the material is a bottle.

4. The method of claim 1 wherein the label is exposed to sprayed or jetted hot gas or sprayed or jetted hot liquid.

5. The method of claim 1 wherein the label is exposed to one or more of heat and gas in a steam tunnel.

6. The method of claim 1 wherein the label is exposed to heat, gas, or liquid steam in a rotary drum.

7. The method of claim 1 wherein prior to removal the label is affixed to the material with a water sensitive adhesive.

8. The method of claim 1 wherein prior to removal the label is affixed to the material with a removable adhesive.

9. The method of claim 1 wherein the label or a layer thereof undergoes dimensional change upon exposure to heat, hot liquid, or hot water.

10. The method of claim 9 wherein the label or a layer thereof undergoes a positive dimensional change and expands upon exposure to heat, hot liquid, or hot water.

11. The method of claim 1 wherein the hot gas is steam having a temperature of about 100° C.

12. The method of claim 1 wherein the method is conducted prior to washing the material for reuse or recycling.

13. The method of claim 1 wherein the label is exposed to hot liquid having a temperature of about 50° C. to about 99° C.

14. The method of claim 13 wherein the hot liquid is water.

15. The method of claim 14 wherein the water has a temperature of at least about 50° C. to about 99° C.

16. The method of claim 1 wherein the label is exposed to hot gas having a temperature of about 50° C. to about 800° C.

17. The method of claim 16 wherein the hot gas is air.

18. The method of claim 1 wherein the label is exposed to heat having a temperature of at least about 50° C.

19. The method of any one of claim 18 wherein the heat has a temperature of about 50° C. to about 800° C.

20. The method of claim 1 wherein the label is substantially removed from the material after an exposure time of less than about two minutes.

21. The method of claim 1 wherein the label is substantially removed from the material after an exposure time of no greater than about two minutes.

22. The method of claim 1 wherein the label is substantially removed from the material after an exposure time of about thirty seconds or less.

23. The method of claim 1 wherein the label is exposed to hot gas or hot liquid and wherein the hot gas or hot liquid are provided at high pressure.

24. The method of claim 1 wherein the label is heated to reach a predetermined temperature.

25. The method of claim 24 wherein the predetermined temperature is 50° C.

26. The method of claim 24 wherein the predetermined temperature is greater than 50° C.

27. The method of claim 1 wherein the label is initially exposed to heat, hot gas, or liquid at edges of the label.

28. The method of claim 1 wherein the label is a shrink label.

29. The method of claim 28 wherein the label is a shrink label and the predetermined temperature is about 80° or greater.

30. The method of claim 1 wherein the material is washed for reuse after the label is removed.

31. The method of claim 30 wherein washing of the label for reuse comprises soaking the material in a caustic bath.

32. The method of claim 1 wherein the label is exposed to heat, hot gas, or hot liquid by providing heat, hot gas, or hot liquid from a directional nozzle configured such that the heat, hot gas, or liquid contacts the label after emission from the nozzle.
